(19) United States
(12) Patent Application Publication
(10) Pub. No.: US 2019/0164240 A1
(43) Pub. Date: May 30, 2019

(54) Apparatus and Methods for Generating Real Estate Alerts Associated with On-Premise Beacon Devices

(71) Applicant: Curbsy Limited, Douglas (IM)

(72) Inventor: Lydia Barbara, Douglas (IM)

(21) Appl. No.: 16/200,414

(22) Filed: Nov. 26, 2018

Related U.S. Application Data
(60) Provisional application No. 62/591,723, filed on Nov. 28, 2017.

(51) Int. Cl. G06Q 50/16; G06F 16/909

(52) U.S. Cl. CPC G06Q 50/163; G06F 16/909

(57) ABSTRACT

Apparatus and methods related to beacon devices are provided. A computing device can receive information about a potential purchase of real estate, the information including desired-feature data related to desired real estate features. The computing device can determine a recommendation percentage for a particular parcel of real estate based on the desired-feature data. The computing device can receive proximity information about a proximity to the particular parcel of real estate. After receiving the proximity information, the computing device can determine whether the recommendation percentage for the particular parcel of real estate exceeds a threshold recommendation percentage. After determining that the recommendation percentage for the particular parcel of real estate exceeds the threshold recommendation percentage, the computing device can generate a notification about the particular parcel of real estate.

### CROSS-REFERENCE TO RELATED APPLICATIONS

This application claims priority to U.S. Pat. App. No. 62/591,723, filed on Nov. 28, 2017, entitled “Apparatus and Methods for Generating Real Estate Alerts Associated with On-Premise Beacon Devices”, the contents of which are fully incorporated by reference herein for all purposes.

### BACKGROUND

Today, computing devices are often involved in commercial transactions, such as purchasing and selling goods. These computing devices can provide information about goods for sale, competing goods, and can even be used to complete purchase and sales transactions.

Also, computing devices can be used for rental, sale, and purchase of real estate, such as condominiums (condos), attached homes, detached homes, commercial real estate, and vacant lots. For real estate transactions, computing devices can be used to search for real estate, put buyers and sellers and/or their agents in contact, and to arrange for financing for real estate rentals and purchases.

### SUMMARY

In one aspect, a method is provided. A computing device receives information about a potential purchase of real estate. The information including desired-feature data related to desired real estate features. The computing device determines a recommendation percentage for a particular parcel of real estate based on the desired-feature data. The computing device receives proximity information about a proximity to the particular parcel of real estate. After receiving the proximity information, the computing device determines whether the recommendation percentage for the particular parcel of real estate exceeds a threshold recommendation percentage. After determining that the recommendation percentage for the particular parcel of real estate exceeds the threshold recommendation percentage, the computing device generates a notification about the particular parcel of real estate.

In another aspect, a system is provided. The system includes a computing device. The computing device includes one or more processors and one or more computer-readable media with computer-executable instructions stored thereon that, when executed by the one or more processors of the computing device, cause the computing device to perform functions. The functions include: receiving information about a potential purchase of real estate, the information including desired-feature data related to desired real estate features; determining a recommendation percentage for a particular parcel of real estate based on the desired-feature data; receiving proximity information about a proximity to the particular parcel of real estate, after receiving the proximity information, determining whether the recommendation percentage for the particular parcel of real estate exceeds a threshold recommendation percentage; and after determining that the recommendation percentage for the particular parcel of real estate exceeds the threshold recommendation percentage, generating a notification about the particular parcel of real estate.

In another aspect, a computer readable medium is provided. The computer readable medium has stored thereon instructions, that when executed by one or more processors of a computing device, cause the computing device to perform functions. The functions include: receiving information about a potential purchase of real estate, the information including desired-feature data related to desired real estate features; determining a recommendation percentage for a particular parcel of real estate based on the desired-feature data; receiving proximity information about a proximity to the particular parcel of real estate, after receiving the proximity information, determining whether the recommendation percentage for the particular parcel of real estate exceeds a threshold recommendation percentage; and after determining that the recommendation percentage for the particular parcel of real estate exceeds the threshold recommendation percentage, generating a notification about the particular parcel of real estate.

In another aspect, a computing device is provided. The computing device includes: means for receiving information about a potential purchase of real estate, the information including desired-feature data related to desired real estate features; means for determining a recommendation percentage for a particular parcel of real estate based on the desired-feature data; means for receiving proximity information about a proximity to the particular parcel of real estate, means for, after receiving the proximity information, determining whether the recommendation percentage for the particular parcel of real estate exceeds a threshold recommendation percentage; and means for, after determining that the recommendation percentage for the particular parcel of real estate exceeds the threshold recommendation percentage, generating a notification about the particular parcel of real estate.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 shows a real estate purchasing system including a computing device with a user interface displaying a questionnaire, in accordance with at least some example embodiments.

FIG. 2 shows two beacons, in accordance with at least some example embodiments.

FIG. 3 shows a communication flow for a scenario involving obtaining information about prospective real estate purchases using beacons, in accordance with at least some example embodiments.

FIG. 4 shows a user interface of a computing device displaying dashboards for the scenario of FIG. 3, in accordance with at least some example embodiments.

FIG. 5 shows a communication flow for a scenario involving obtaining information about prospective real estate purchases using a server computing device in accordance with at least some example embodiments.

FIG. 6 depicts a distributed computing architecture, in accordance with at least some example embodiments.

FIG. 7 is a functional block diagram of an example computing device, in accordance with at least some example embodiments.

FIG. 8 is a flowchart of a method, in accordance with at least some example embodiments.

### DETAILED DESCRIPTION

Generating Real Estate Alerts Associated with On-Premise Beacon Devices

Herein are described apparatus and methods related to buying and selling real estate; in particular, using beacon devices associated with parcels of real estate available for purchase or rental. A parcel of real estate can be or include, property including one or more portions of land, buildings, fixtures, and/or other associated items. Example parcels of real estate include, but are not limited to, residential buildings and land (e.g., homes, condominiums, town houses), commercial buildings and land (e.g., shops, office buildings, warehouses, retail stores/buildings), industrial buildings and land (e.g., factories, mines, farms), undeveloped/vacant land, parking places/parking lots, and resources associated with/appurtenant to land (e.g., mineral rights, water/water rights, livestock, garages).

A herein-described recommendation algorithm can match people, such as potential buyers and renters, to parcels of real estate, based on their ideal lifestyle. The underlying premise is that people choose a home not because it has the appropriate number of bedrooms in a specific location, but rather because they fall in love with the lifestyle they imagine they could have in that house. Upon registration a real estate purchasing system that includes the recommendation algorithm can ask a prospective purchaser or renter of real estate a series of questions to determine their desired lifestyle. Based on responses to those questions, and perhaps additional data, the recommendation algorithm can determine recommendation percentages.

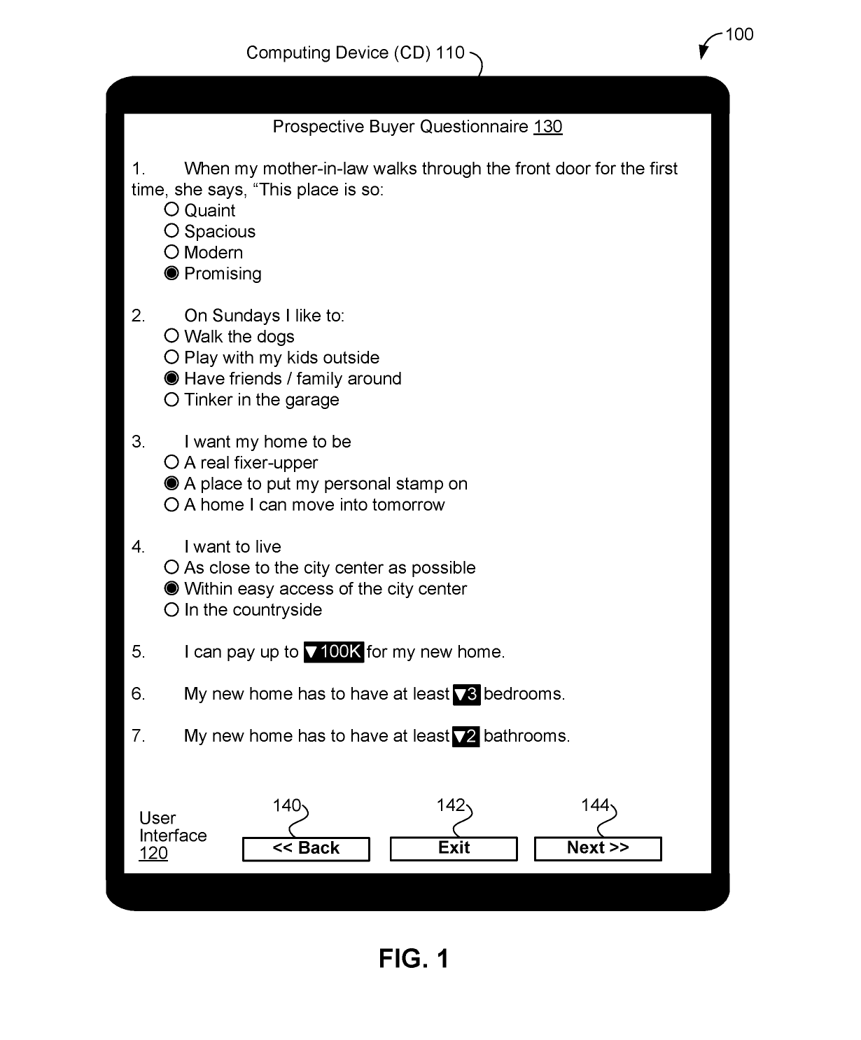

FIG. 1 shows real estate purchasing system 100 including computing device 110 with user interface 120 displaying questionnaire 130, in accordance with at least some example embodiments. In some examples, real estate purchasing system 100 can include one or more server computing devices (not shown in FIG. 1) that can communicate with computing device 110; e.g., to receive and process data provided using questionnaire 130. In particular other examples, data provided using questionnaire 130 is not shared with other computing devices outside of real estate purchasing system 100 before computing device 110 receives specific consent to share this data. In this document, application App1 is an example software application executing on computing device 110 that can provide user interface 120, questionnaire 130, and access to the recommendation algorithm, among other functionality as discussed below. In some embodiments, some or all of the herein-described functionality of App1, questionnaire 130, and/or the recommendation algorithm can be performed by one or more other computing devices than computing device 110; e.g., some or all of the recommendation algorithm can be executed by one or more server computing devices that can provide recommendation percentages and/or lists of recommended parcels of real estate computing device 110. In other embodiments, a list of recommended parcels can include a list of recommended parcels and a list of “almost-recommended” parcels. A recommended parcel can be a parcel that has a recommendation percentage determined by the recommendation algorithm that exceeds a threshold recommendation percentage. And, an almost-recommended parcel is a parcel whose recommendation percentage is just below the threshold recommendation percentage; e.g., is within 0.25%, 0.5%, 1%, 2%, 2.22%, 2.5%, etc. of the threshold recommendation percentage

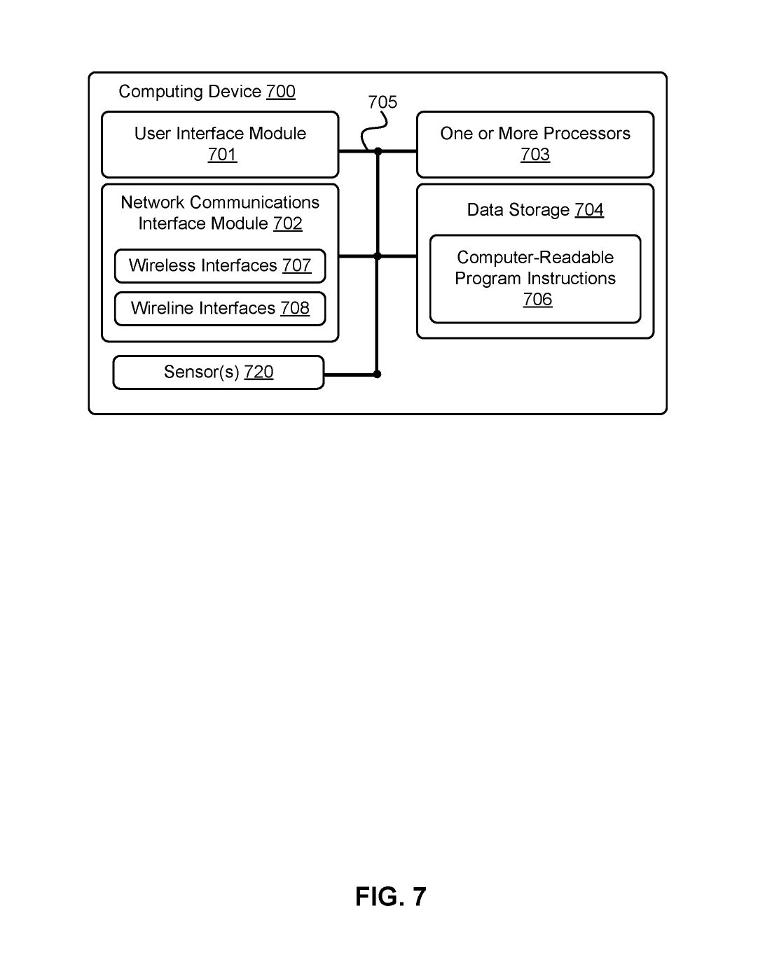

User interface 120 of computing device 110 can be configured to display and receive inputs related to questionnaire 130. For example, as indicated by FIG. 1, user interface 120 can be a graphical user interface (GUI) that can receive inputs using one or more user input devices and provide data using one or more user output devices, such as discussed below in the context of at least FIG. 7.

Questionnaire 130 includes seven questions and related responses related to potential purchase of residential real estate. FIG. 1 shows that questionnaire 130 includes a question “1” of: “When my mother-in-law walks through the front door for the first time, she says, ‘This place is so:” with possible responses as “Quaint”, “Spacious”, “Modern”, “Promising.” In the example shown in FIG. 1, question 1 has been answered with a response of “Promising” as indicated by a filled-in radio button provided by user interface 120 for questionnaire 130. The remaining three possible responses for question 1 are not selected as answers as indicated by non-filled-in radio buttons provided by user interface 120 for questionnaire 130.

Questionnaire 130 also includes a question “2” of: “On Sundays I like to:” with possible responses of “Walk the dogs”, “Play with my kids outside”, “Have friends/family around”, and “Tinker in the garage”, with an answered response of “Have friends/family around”. Questionnaire 130 also includes a question “3” of: “I want my home to be” with possible responses of “A real fixer-upper”, “A place to put my personal stamp on”, and “A home I can move into tomorrow”, with an answered response of “A place to put my personal stamp on”.

Questionnaire 130 further includes a question “4” of “I want to live” with possible responses of “As close to the city center as possible”, “Within easy access of the city center”, and “In the countryside”, with an answered response of “Within easy access of the city center”.

Questionnaire 130 further includes a question “5” of “I can pay up to” with a dropdown user interface (UI) element to indicate a price for desirable real estate, a question “6” of “My new home has to have at least” with a dropdown UI element to indicate a number of “bedrooms”, and a question “7” of “My new home has to have at least” with a dropdown UI element to indicate a number of “bathrooms”.

The questions in questionnaire 130 will relate to quantitative features of desirable real estate (e.g., price, number of bedrooms, number of bathrooms, presence of amenities, amount of land) and/or qualitative features of desirable real estate (e.g., home style, readiness for occupancy, aspects of the floor plan, etc.) and/or geographic information (e.g., proximity to schools or workplace, reported crime statistics for the neighborhood, ratio of bars or churches to population, population density, etc.). For example, questions 1-4 of questionnaire 130 can be considered to be questions about qualitative features of desirable real estate, as they do not have numerical answers, and Questions 5-7 of questionnaire 130 can be can be considered to be qualitative features of desirable real estate. In other examples, questionnaire 130 can have more, fewer, and/or different questions and/or related responses and/or can be related to potential purchase of other types of real estate than residential real estate and/or related to potential rental of real estate. Then, the responses to these questions can include information about a potential purchase of real estate, the information including desired-feature data related to desired real estate features; e.g., features such as price, rooms, location of real estate, condition of real estate, etc. at least as described in the context of questionnaire 130.

In some examples, questions in questionnaire 130 can be determined, at least in part, dynamically by the recommendation algorithm. IN these examples, an initial set of one or more questions can be asked and answered using questionnaire 130 or a similar questionnaire. Upon receiving the answers to the initial set of questions, computing device 110 can use user interface 120 to ask further questions related to real estate as a potential buyer (or renter) progresses through their search for real estate. These further questions which may not appear sequentially, but rather as needed in order to provide information to the recommendation algorithm for refining recommendations; e.g., to enable the recommendation algorithm to learn the potential buyer's (or renter's) preferences about real estate. Once preferences of the potential buyer (or renter) are learned, the recommendation algorithm should not need to ask as many questions about these preferences and/or can ask questions for more information about the specified preferences.

More particularly, after answering the initial set of questions, the potential buyer (or renter) can search for real estate using one or more search queries. These search queries can be populated, at least in part, by data from the answers to the initial set of questions. Once populated, the search queries can be provided to one or more websites for property searches, and resulting search results can be responsively obtained at computing device 110. The recommendation algorithm can examine the search results in order to determine further questions for refining recommendations. For example, if the search results show a property with a pool (or other feature), then the recommendation algorithm can examine at the answers provided to the initial set of questions (and any additional questions already asked and answered) to see if there are any answers related to a pool (or other feature). If the recommendation algorithm does not find any answers related to a pool (or other feature), then the recommendation algorithm can utilize user interface 120 to ask at least one additional question related to a pool (or other feature), receive a related answer, and store data about the additional question(s) and related answer(s), thereby learning the potential buyer's (or renter's) preferences about various features of real estate. Once preferences of the potential buyer (or renter) are learned, the recommendation algorithm should not need to ask as many questions about these preferences; e.g., after receiving the answer(s) to the at least one additional question related to a pool, the recommendation algorithm need not ask as many questions related to the pool.

In some examples, additional questions and/or potential real estate choices can be displayed by App1 that are determined in part by answers to the previous questions. For example, an answer to Question 2 of “Play with my kids outside” can cause computing device 110 to generate and/or display further questions in questionnaire 130 about the importance of proximity to school districts and/or to the quality of school districts. As another example, an answer to Question 3 of “A real fixer-upper” can indicate that a house with two bedrooms and a large loft with planning permission for a bedroom conversion can be a potential real estate choice for a person seeking a home with three bedrooms who is open to renovating a property.

In other examples, along with data provided by questionnaire 130, the recommendation algorithm can use additional data to determine a recommendation percentage. The recommendation percentage can provide a numerical indication of a match between a potential buyer's (or renter's) criteria for purchasing (or renting) real estate and criteria of a particular parcel of real estate. This additional data about the particular parcel of real estate can include, but is not limited to, data about one or more of:
Previous search queries and related search results
Viewing time on specific photos,
Metadata from photos to determine room size/coziness (or openness),
The number of photos per home viewed by different user segments,
Social media shares of home listings and photos.
Actual purchases of homes vs recommendation percentages for those homes,
Ratio of scheduled home viewings to purchases; e.g., a measure or proxy for a measure of an efficient use of home showings.
Ongoing maintenance costs
Accessibility to and within the home for disabled users, either available as is or possibility to change (e.g., availability of an elevator, lack of stairs, walk-in shower, etc.)
User-reported budget information
House layout and flow
Entrance to the home, such as stairs vs elevators
Proximity to neighbors', friends' and/or family member's homes
Proximity to bars, restaurants and/or other entertainment choices (e.g., concert venues)
Proximity to churches or other historical and/or religious locations
Proximity to other addresses, such as their office
Proximity to public transport and/or airports
Direction of the sun in relationship to the home (e.g., some buyers favor sunny homes, while others favor less light)
Proximity to specific schools and/or highly-rated school districts
Crime statistics of the surrounding area
Population density of the surrounding area
“Mood” of the surrounding area—artsy/edgy vs picket-fenced
Recreational/sports-related features (e.g., swimming pool, basketball court, tennis court) of the home and/or potential to add such features at a later date
Parking information (e.g., garage parking or on-street parking).

In still other examples, questionnaire 130 can include imagery in questions about desirable real estate. For example, questionnaire 130 can display an image of a potential real estate choice (perhaps an image of real estate that meets criteria already indicated by responses to questionnaire 130), and the question “Do you like this home” can be answered in the affirmative or negative using swipe left/swipe right UI elements of user interface 120 and questionnaire 130. The selected images can then be processed by the recommendation algorithm using image processing and/or machine learning techniques to determine other potential real estate choices that match the affirmatively selected images.

As another example, search results can be processed to generate additional questions, ask those additional questions, and receive and store responses to those additional questions. For example, textual and/or image processing of search results provided in response to a search for a desired property can return information about P properties with text for each property and a total of IM images for the P properties. Then text and/or image processing techniques can be used to determine features in the P properties; e.g., the text for each property can be scanned for terms related to features in the P properties, images can be processed to find images to features in the P properties. For example, image processing of the IM images can indicate that F1 of the IM images show a first feature (e.g., a pool), F2 of the IM images have a second feature (e.g., a fence), and so on. Then, a ratio of images having a feature to the total number of images can be used to determine whether to ask additional questions about the feature; e.g., let ratio R1=F1/IM. Then, if R1 exceeds a threshold value (e.g., 1/100^{th}, 1/10^{th}, ⅕^{th}, 3/10^{th}, 1/3, etc.), the recommendation algorithm can generate additional questions about feature F1; e.g., “On a scale of 0-10, how much do you want to have a pool with your home (0=undesirable, 10=must have)”, “Do you want a big pool (greater than 10 m²) pool, medium pool between 5-10 m²), or a small pool (less than 5 m²) ?”, “Do you want an indoor pool, an outdoor pool, both, or neither?”

Then, data provided by questionnaire 130, additional data, and/or affirmatively-selected images can be processed by application App1 and/or the recommendation algorithm to determine recommendation percentages and thereby make recommendations regarding potential real estate choices. The recommendation algorithm can use image processing, conventional programming, and/or machine learning techniques to determine recommendation percentages for one or more parcels of real estate, and make recommendations to a potential buyer (or renter) about real estate that the potential buyer (renter) is looking for based on the recommendation percentages.

For example, suppose that values of a recommendation percentage for real estate parcels range from a minimum value of MnP (e.g., 0) indicating no recommendation to a maximum value of MxP (e.g., 100) indicating a strongest possible recommendation. Then, the recommendation algorithm can determine the recommendation percentages RP1, RP2 . . . RPN for one or more parcels of real estate Parcel1, Parcel2 . . . ParcelN based on the data provided via questionnaire 130, additional data, photos, etc. using image processing, conventional programming, and/or machine learning techniques in the range [MnP, MxP] for each of Parcel1, Parcel2 . . . ParcelN.

In some examples, the recommendation algorithm can compare some or all of the recommendation percentages RP1, RP2 . . . RPN to a threshold recommendation value RPThresh. When a recommendation percentage RPx (x=1 to N) exceeds RPThresh, then the recommendation algorithm can recommend Parcelx for consideration and possible purchase (or rental) to the potential buyer (or renter). Example values of threshold RPThresh can be a predetermined value (e.g., 51, 80, 90, 92.35, 99), a predetermined percentage of MxP (e.g., 50%, 66%, 75%, of MxP), a percentage of the difference between MnP and MxP (e.g., 45%, 75%, 80%, 95% of (MxP−MnP). In these examples, if one or more parcels of have a recommendation percentage that exceeds the threshold percentage, then the recommendation algorithm can generate a list of the one or more parcels that exceed the threshold percentage as a recommended parcel list; otherwise, if no parcels of real estate have a recommendation percentage that exceeds the threshold percentage, then the recommendation algorithm can generate an indication that no parcel is currently recommended for purchase (or rental). In related examples, the recommendation algorithm can generate an almost-recommended list of parcels as discussed above for parcels whose recommendation percentage is less than threshold RPThresh but is within a predetermined value of RPThresh; e.g., a recommended percentage that is within 0.25%, 0.5%, 1%, 2%, 2.22%, 2.5%, etc. of the threshold recommendation percentage.

In other examples, the recommendation algorithm can compare some or all of the recommendation percentages RP1, RP2 . . . RPN to multiple threshold recommendation values RPThresh1, RPThresh2 . . . RPThreshM, where M>1, and where RPThresh1>RPThresh2> . . . RPThreshM. When a recommendation percentage RPx (x=1 to N) exceeds or equals RPThresh1, then a first recommendation of Parcelx can be output for consideration and possible purchase (or rental) to the potential buyer (or renter)—for example, the first recommendation can recommend Parcelx as a “Superior Match”, “Great Match”, “Selected Just for You”, “Tier 1 Match” etc. Then, if the recommendation percentage RPx is less than RPThresh1 but exceeds or equals RPThresh2, then a second recommendation of Parcelx can be output for consideration and possible purchase (or rental) to the potential buyer (or renter), where the second recommendation is a lesser qualitative recommendation than the first recommendation; e.g., the second recommendation can recommend Parcelx as an “Excellent Match” if the first match is a “Superior Match”, as a “Good Match” if the first recommendation is a “Great Match”, as a “Tier 2 Match” if the first recommendation is a “Tier 1 Match”, etc. This procedure of outputting lesser recommendations based on recommendation percentages exceeding or equaling decreasing recommendation thresholds can be continued until reaching RPThreshM. Upon reaching RPThreshM, the recommendation algorithm can determine whether the recommendation percentage RPx is less than RPThresh(M−1) but exceeds or equals RPThreshM—if so, a M^{th} recommendation of Parcelx can be provided for consideration and possible purchase (or rental) to the potential buyer (or renter), where the M^{th} recommendation is a lesser qualitative recommendation than the first, second . . . M−1^{st} recommendation. Otherwise, the recommendation percentage RPx is less than RPThreshM (and therefore is less the RPThresh1, RPThresh2 . . . RPThresh(M−1)), and so no recommendation may be output for Parcelx by the recommendation algorithm. In other related examples, the recommendation algorithm can generate a “You might also like” list that lists properties that are below the RPThresh threshold (or some or all of the RPThreshM thresholds), but rank very highly in a couple of desired attributes (e.g. a buyer or renter wanted 3 bedrooms where they could dine out every night so the “you might like” list could include a 5 bedroom house in the city that may not be close to a large number of restaurants).

In still other examples, the recommendation algorithm can provide a recommended parcel list of M (0<M<N) parcels having the top M corresponding recommendation scores as being recommended for purchase (or rental) by the recommendation algorithm. In still other examples, a combination of approaches; e.g., providing a recommended parcel list of the top M parcels whose recommendation percentages exceed threshold RPThresh, can be used by the recommendation algorithm.

Once the recommendation algorithm has determined the recommended parcel list for the potential buyer (or renter), the recommendation algorithm can output the list (or a related data structure) of the one or more parcels. The recommended parcel list can be sorted in order of recommendation percentage, price, proximity to one or more desired locations, and/or other criteria. Then, computing device 110 can use user interface 120 to display the recommended parcel list.

User interface 120 also includes back button 140 to display and perhaps answer previously-displayed questions of questionnaire 130, next button 144 to display and perhaps answer additional questions of questionnaire 130, and exit button 142 to exit an application providing user interface 120 and/or questionnaire 130. In some examples, more, fewer, and/or different buttons and/or UI elements can be provided by application App1, user interface 120, and/or questionnaire 130.

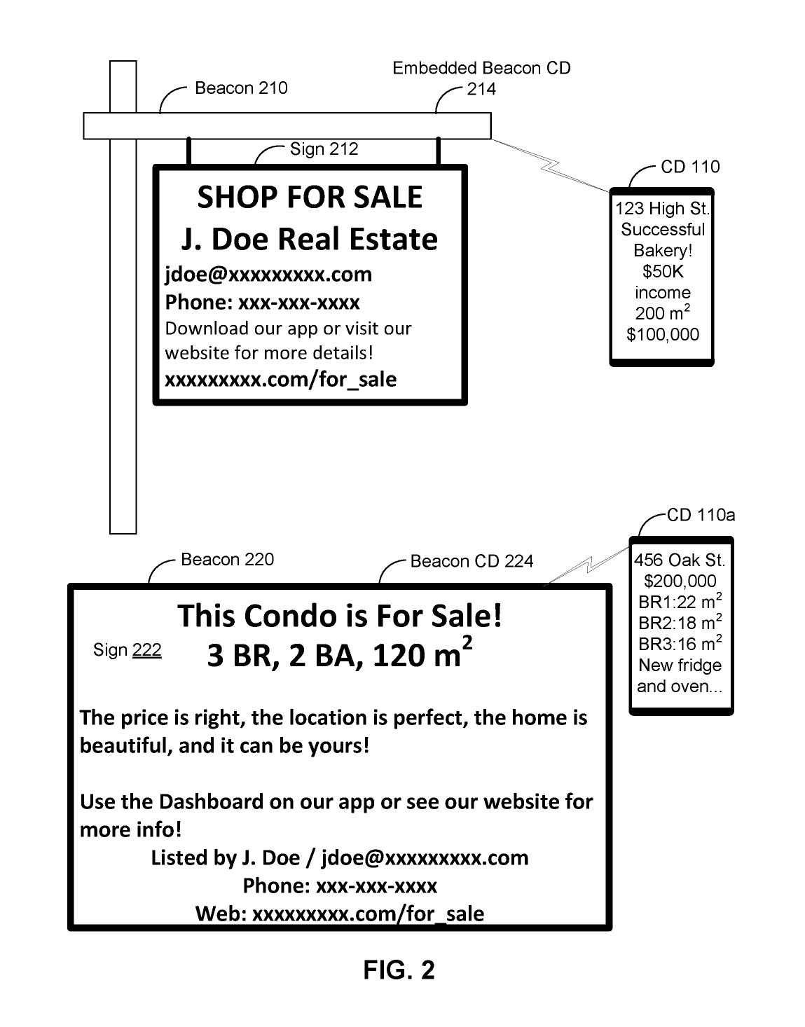

FIG. 2 shows two beacons 210, 220 in accordance with at least some example embodiments. A beacon is a device that can provide information about one or more parcels of real estate. A beacon can be placed on or near a parcel of real estate that is for sale or rent. Then, when a potential purchaser or tenant of the real estate comes near to the beacon, the beacon can provide information about the parcel of real estate that is for sale or rent. In some examples, beacons can be used along with other techniques (such as geo-fencing) to provide information about one or more parcels of real estate. In some examples, beacons 210, 220 can utilize and/or be supplemented by Global Positioning System (GPS)-based location services. Such GPS-based location services can be accessed via smart phones and the user will receive a push notification when he/she is near a suitable property.

In the examples shown in FIG. 2, each of beacons 210, 220 provides a respective sign 212, 222 for advertising a parcel of real estate, and a respective embedded beacon computing device 214, 224, where the respective beacon computing devices 214, 224 can execute the recommendation algorithm, executed a related algorithm, and/or access a computing device executing the recommendation algorithm (e.g., access a server) to determine whether an owner of a computing device CDNear that is near to the beacon is likely to be a potential purchaser or tenant of the real estate. Then, if the owner is a likely to be a potential purchaser or tenant of the real estate, the beacon can use one or more wireless communications technologies, such as but not limited to, one or more of Bluetooth™ Zigbee®, Wi-Fi™, WiMAX™, LTE, 2G, 3G, 4G, and 5G wireless technologies, to communicate information about the real estate to computing device CDNear.

For example, a beacon can be configured as a sign, such as beacon 210 configured as sign 212 as shown in an upper portion of FIG. 2. Beacon 210 also embeds beacon computing device 214 which can be used to transmit information about a parcel of real estate, such as the parcel of real estate where beacon 210 is located, proximity information related to the parcel of real estate, and perhaps receive information about potential purchasers and/or tenants of the parcel of real estate. Then, beacon 210/sign 212 can be placed at the parcel of real estate to advertise that the parcel of real estate is for sale.

In some examples, a beacon computing device can be configured to initially run in a low power mode, such as a mode where the beacon computing device is operating communications interfaces in a receive-only mode. The beacon computing device can run in the low power mode to preserve power, extend battery life, and/or avoid congestion on communications links used by the beacon computing device. Then, upon reception of a trigger, such as a beacon query message from a computing device associated with a potential purchaser or renter of a parcel of real estate RE1 associated with the beacon computing device, such as a message from CDNear, the beacon computing device can change from operation in the low power mode into a high power mode, where the beacon computing device can send and/or receive one or more messages to CDNear to determine whether the owner of CDNear is interested in RE1, and possibly send information about RE1 to CDNear. After sending the information about RE1 to CDNear, the beacon computing device can return to running in the low power mode. In other examples, a beacon computing device can always operate in the high power mode; e.g., if the beacon and/or beacon computing device is plugged into an electrical power outlet.

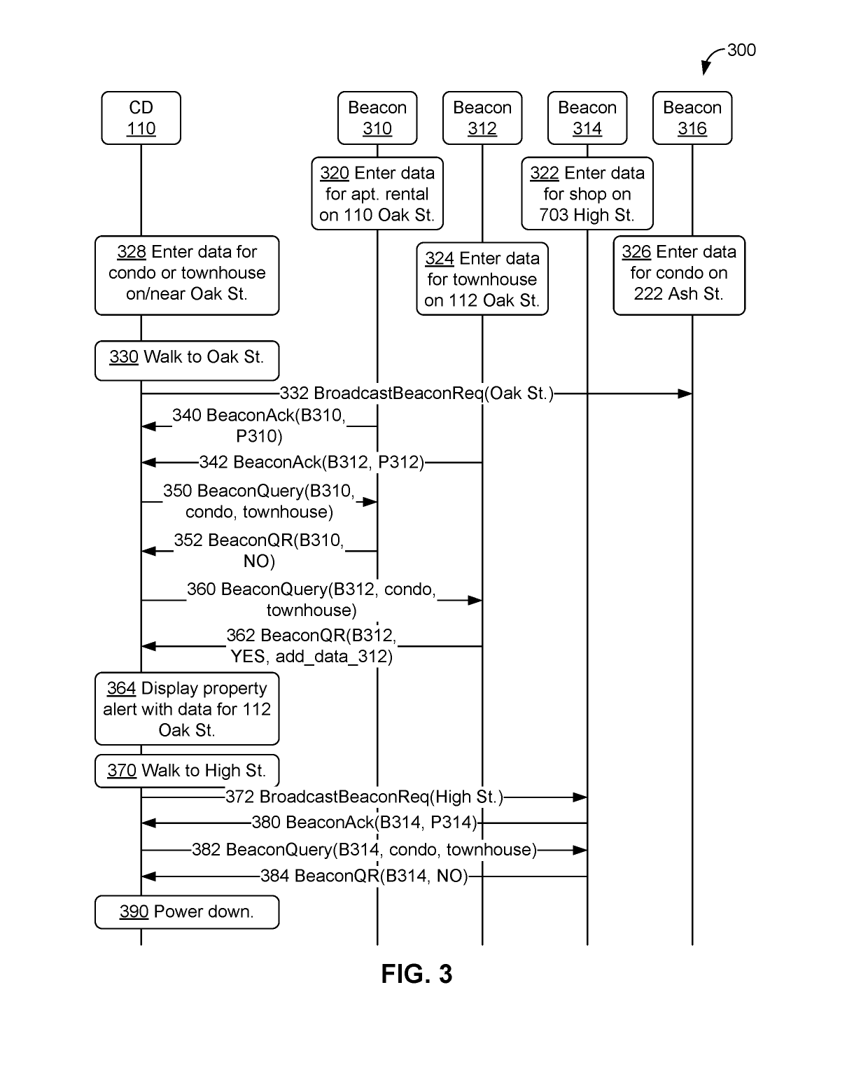

After installation of beacon 210 at the parcel of real estate, beacon computing device 214 can communicate with one or more applications executing on computing device 110 to provide information about the parcel of real estate. If a person is walking/driving near a beacon 210, beacon computing device 214 can communicate with a computing device used by the person, such as computing device 110 shown in FIG. 2, to determine whether the person is a potential buyer (or tenant) of the parcel of real estate. In some examples, a recommendation algorithm executing on beacon computing device 214 and/or App1 executing on computing device 110 can be used to initiate communications between computing device 110 and beacon 210/beacon computing device 214 Details of communications related to this determination are discussed below in the context of at least FIG. 3. If the person is determined to be a potential buyer (or tenant) of the parcel of real estate (i.e., the recommendation algorithm determines that a recommendation percentage for the parcel of real estate exceeds a threshold value), then beacon computing device 214 can provide information about the parcel of real estate to computing device 110.

For example, computing device 110 has executed App1 providing questionnaire 130, where the owner of computing device 110 indicated that the owner was interested in buying a shop on or near High Street. Then, in this example, an instance of the recommendation algorithm executing on beacon computing device 214 and/or another computing device accessible by beacon computing device 214 can determine that the recommendation percentage for the parcel of real estate where beacon 210 is located exceeds a threshold value, based on the answers to questionnaire 130 provided by the owner of computing device 110. Then the recommendation algorithm can cause beacon computing device 214 to provide a push notification to computing device 110 with information about the parcel of real estate, such as the message with an address “123 High St.”, information about the parcel “Successful Bakery! $50K income 200 m² $100,000” as shown in the upper portion of FIG. 2, and perhaps a link or message to provide even more information about the parcel of real estate.

As another example, computing device 110a, shown in a lower portion of FIG. 2, has executed App1 that provided questionnaire 130, where the owner of computing device 110a indicated that the owner was interested in buying a home in the city. In this example, beacon 220, which is in the form of an electronic sign, is placed in a window of a condominium at 456 Oak St., which is in the city, and beacon computing device 222 is activated. Then, in this example, an instance of the recommendation algorithm executing on beacon computing device 222 and/or another computing device accessible by beacon computing device 222 can determine that the recommendation percentage for the parcel of real estate where beacon 220 is located exceeds a threshold value, based on the answers to questionnaire 130 provided by the owner of computing device 110a. Continuing this example, beacon computing device 222 can provide a push notification to computing device 110a with information about the parcel of real estate, such as the message with an address “456 Oak St.”, a price of “$200,000” and information about features of the real estate such as bedroom sizes “BR1:22 m²”, “BR2:18 m²”, “BR3:16 m²”, and that there is a “New fridge and oven” as shown in the lower portion of FIG. 2, and perhaps a link or message to provide even more information about the parcel of real estate.

In some examples, the push notification can include a Quick Response (QR) code. Then, an application receiving the push notification can be use a QR code reader to read the QR code and responsively determine property details embedded in the QR code. The application can then display the property details obtained using the QR code. In particular examples, beacon computing device 222 can provide a QR code embedded with the link or message to provide even more information about the parcel of real estate; e.g., by accessing the link to a relevant web page with more information about the parcel of real estate;

In some examples, the instance of the recommendation algorithm executing on and/or accessible by beacon computing device 222 can send information about received queries and/or other messages received at beacon computing device to one or more other computing devices; e.g., one or more real-estate-related servers. The information about received queries and/or other messages can include, but is not limited to, time and location of received queries and/or other messages, data included in the queries and/or other messages, and/or networking information associated with the queries and/or other messages (e.g., network address information).

In the examples shown in FIG. 2, both beacons 210 and 220 provide electronic signs, while in other embodiments, a beacon can include a non-electronic sign or other advertisement rather than or along with an electronic sign. In still other examples, a beacon computing device can be placed on or near the parcel of real estate and activated without being attached to a sign; e.g., for a discreet and/or electronic-only property listing.

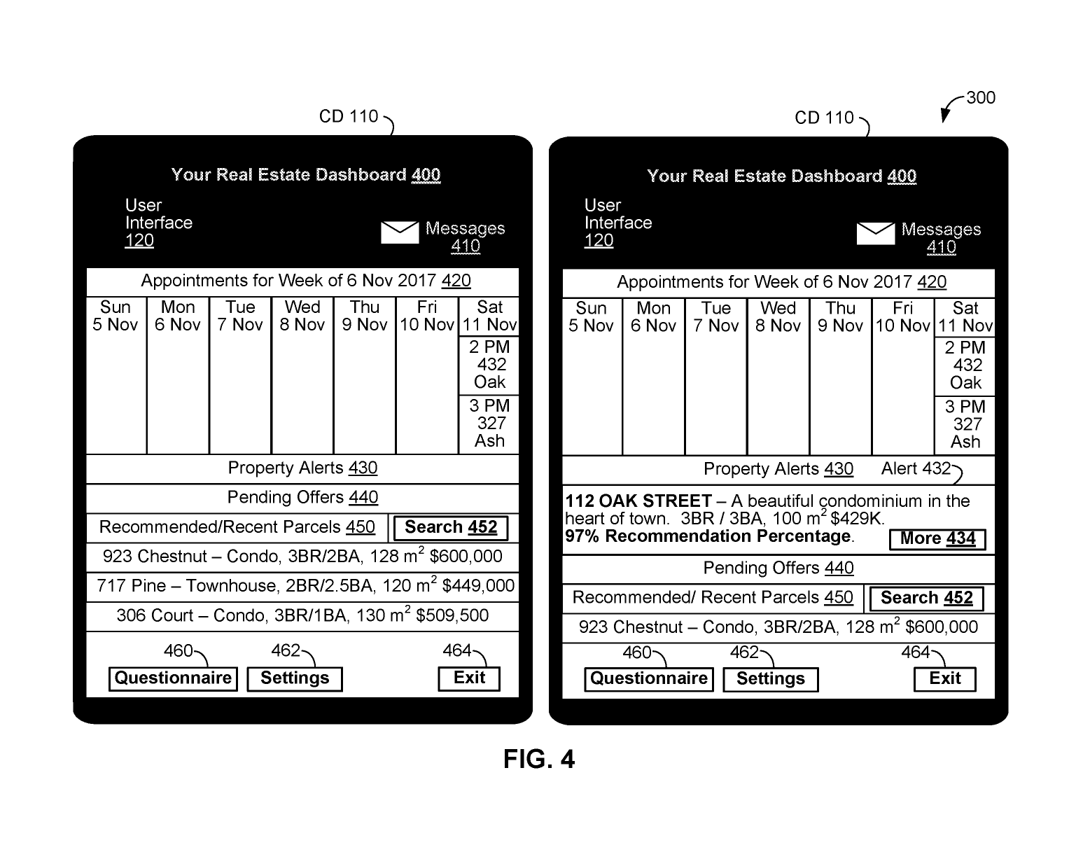

In some scenarios, a user U_FS1 of computing device 110 can travel to a location L_FS1, where location L_FS1 is at or near a For Sale sign, such as sign 212 or 222, which is located at or near a parcel of real estate. In some of these scenarios, the For Sale sign does not have a beacon and/or beacon computing device. For example, upon observing the parcel of real estate and the For Sale sign at L_FS1, user U_FS1 desires to learn more about the parcel of real estate. Then, user U_FS1 executes App1 on computing device 110, perhaps after downloading App1 (e.g., if App1 was not already resident on computing device 110). Using App1, user U_FS1 learns that the parcel of real estate associated with L_FS1 is a house that is for sale and so U_FS1 can use App1 to review details about the house and/or other parcels of real estate. To obtain the details about the parcel of real estate associated with L_FS1, the user of computing device 110 can use App1 to generate and send one or more queries to one or more servers and/or beacon computing devices associated with the parcel of real estate; e.g., one or more queries for information about parcels of real estate located at or near location L_FS1 perhaps that meet criteria that are specified by answers to questions of questionnaire 130. In response to the one or more queries, the server(s) and/or beacon computing device(s) can send query responses with data that includes the details about the parcel of real estate located at or near location L_FS1 to computing device 110. Upon reception of the query responses, App1 can generate one or more notifications about the query responses—an example notification of data received by from a server or a beacon/beacon computing devices is discussed below as property alert 432 of FIG. 4.

Logged-in users of application App1 and/or a related website can access a personalized dashboard, which can have different information for potential buyers, sellers and agents. In the dashboard, a user can manage information related to real estate, such as a viewing calendar, property alerts, and make/negotiate/accept/reject offers on a home. In some examples, the application App1 can provide conveyancing services. Then, after acceptance of an offer, the conveyancing services can provide displays showing a buyer or seller where they are in the conveyancing process at any time, next steps, and what information is required of them to proceed.

The above-mentioned viewing calendar can be synchronized for potential buyers, sellers and agents. A potential buyer can select a date and time for a home viewing, and that information is then populated into the calendars for both sellers and agents. Only available dates/times will be shown. The dashboard can also provide messaging functionality (e.g., video call functionality, e-mail functionality, text messaging functionality, telephone functionality) for potential buyers and sellers to communicate with each other and/or with customer support personnel. In some examples, App1 can provide the messaging functionality; in other examples, 3^{rd}-party supplied messaging functionality can be invoked by App1.

A potential buyer can make an offer on a home, which the seller can accept, reject or counter. A countered offer goes back to the potential buyer for accept, reject or additional counter. Once an offer is accepted on both sides, the home is immediately shown on the dashboard, website, and application App1 as “sold subject to contract” and any future viewings will be either cancelled or those potential buyers warned that the house is most likely off the market. Additionally, once the offer is accepted by both parties, first the potential owner gets a contract immediately with all home-specific details filled in by application App1 and/or the related conveyancing services. Once a contract is signed by the potential owner, the signed contract given to the potential seller for review and counter-signature. In other examples, the potential seller receives the contract first and then a copy of the contract signed by the potential seller is provided to the potential buyer for review and counter-signature. In still other examples, the potential seller and the potential buyer receive the contract at or about the same time.

The conveyancing services can display information about the entire conveyancing process, from offer to property registration (e.g., indications of documents indicating change of property ownership filed at the Land Registry or other property registrar) with the buyer and seller's places in the process clearly marked. If the next step is in the hands of either party, they will be messaged and will be able to complete as much as possible through the website/app. This system will be displayed in as user-friendly a manner as possible. The intention is to de-mystify the conveyancing process and speed it up for all parties.

When App1 is used by sellers and/or landlords, the dashboard can provide one or more photography and videography options for use in advertising their properties. In some examples, a photographer can use wide-angle lenses to create a feeling of spaciousness in photographs of properties for sale or rent. In other examples, a photographer can use standard lenses and good lighting to provide uniform imagery to potential buyers/renters. The use of uniform imagery can allow a potential buyer/renter to make a more informed decision before visiting a property; i.e., the potential buyer/renter can be half-decided on a property before visiting the property based on realistic and uniform photographic and video imagery.

In still other examples, a seller can choose aerial photography; e.g., hire a drone videographer to take video of their property from air. In particular of these examples, if a seller chooses drone videography, the videographer can provide a video walkthrough of the property and, in some cases, the two videos (aerial and walkthrough) can be stitched together into one video, which can then be uploaded to one or more websites (e.g., a realty website, YouTube, Facebook).

In even other examples, 360° photography can be used; e.g., multiple 360° photographs can be stitched together to create a 360° walkthrough. In particular of these examples, a 360° walkthrough or other walkthrough can be converted and/or otherwise provided as a virtual reality walkthrough.

In further other examples, a live video walkthrough of a property can be provided. For example, a realty agent can travel through the property, perhaps with the owner, and provide commentary and/or ask questions of the owner, perhaps including questions from a live audience of the live video walkthrough. The resulting video can be uploaded to one or more websites. Such walkthroughs can be of interest to sellers/landlords of properties in regions where foreign buyers are common.

The software application App1 and/or a related website can allow a user to visualize changes in one or more rooms of a property. For example, suppose a living room has a floral wallpaper and orange carpet, the potential buyer can click on the walls and floors of a display of the living room. The user can then be prompted on how to change the walls and floors of the living room; e.g., to change the walls to white paint and the floors to hardwood. App1 and/or a related web site can provide a user with an option to show a property with an entirely different design scheme, from traditional to modern or vice versa; i.e., to enable the user to visualize and determine whether a house is right for them despite having cosmetic details and/or a design they would like to change.

App1 and/or a related website can provide such changed details of a property as part of an augmented reality display. The augmented reality display can be displayed on mobile embodiments of computing device 110 are able to display live imagery of the property, such as a smart phone or head mountable display. For example, computing device 110 can receive a video feed showing one or more property-related features (e.g., rooms, landscaping/yard/garden, buildings, exterior siding, roof, etc.) of a property for potential purchase (or rent). The video feed (or other live imagery) can be processed to evaluate the property-related feature(s) and predict how user-specified preferences or user-specified components may appear on the property for potential purchase (or rent). The user-specified preferences or components are then graphically overlaid on the video feed showing the actual property-related feature(s) as part of an augmented reality presentation.

For example, a potential buyer using the augmented reality display could walk into a house and look at a display generated by App1 and/or a related website. The augmented reality display can illustrate a room that has been changed by the user; e.g., a display of a living room of the property showing how the living room would look with the user's furniture (e.g., a sofa) in the living room and/or how the living room would look using a different color of paint or wallpaper. As another example, the augmented reality display can show how a home would look after removing one or more walls (or added) to provide a more open (or cozy) feel to the home. In another example, the augmented reality display can show how a property would look with a pool installed (or removed) and related changes in landscaping. In a further example, the augmented reality display can show how a property would look with a new exterior paint color and/or after installation of new siding. Many other examples of a property being illustrated, including potential alterations of the property, using augmented reality displays are possible as well.

App1 and/or a related website can provide story information about part or all of a property; e.g., a room, a yard, a building, etc. Properties collect stories over time, and these stories may vanish when ownership changes. If a seller (or landlord) wants to share stories and critical information about their properties, App1 and/or a related website can receive such story information from the seller. Then, App1 and/or a related website can act as a platform to sharing the seller-provided information to potential buyers (or renters). Stories can include personal stories, such as “we had our wedding reception on this lawn” or “the living room is our favorite room in summer because it gets so much light”, or practical stories like “we replaced the roof above this room in 2014” or “we have planning permission to extend the kitchen 10 feet into the garden”.

In some examples, story information can be associated with one or more photographs or videos of the properties, thereby enabling a potential buyer to have ready reference to the story information in an informative manner. For example, a (small) tag or other UI element can be added to an image or video to indicate related story information is available. Then, upon selection of the tag, a potential buyer can be provided with the story information. However, if the story information is not of interest to the potential buyer, the use of such a small tag will not intrude on the potential buyer's review of the tagged photo or video. For example, a photo of a room can have a small “Story” tag, that when selected provides story information such as “This living room was built as an extension to the main house in 2010. With the direction the patio doors face, this room stays well-lit later than any of the other rooms in the house. Because of this, the room has become the natural place in the house to hold small parties for our friends and family—it is our favorite room.” In particular of these examples, a book or other printed version of story information and related images can be provided to the seller and/or to the eventual buyer for memorialization (of the seller) and/or for future reference (of the buyer). Some or all of this story information can be provided by the recommendation algorithm, website, a beacon, and/or other entities to a computing device executing App1 as part of a recommendation, alert, indication, and/or another notification about the parcel of real estate associated with the story information.

The use of App1 and/or a related website can be related to a pricing model. Rather than charge commission on sale of a house, a flat fee can be charged for services rendered by the use of App1 and/or a related website. A portion at least of the flat fee can be due before listing. For example, a first flat fee can be charged for “basic” services such as property valuation, photography, listing in one or more listing services (e.g., Multiple Listing Service (MLS)), geo-marketing, perhaps using beacons, and website access. A second flat fee can be charged for providing an agent to show the property to potential buyers (or renters). A third flat fee can be charged for “gorgeous” services that include all basic services, agent showing, property cleaning, video marketing (including aerial videography where available), 360° walkthroughs, and conveyancing services. A fourth flat fee can be charged for “premium” services that include all gorgeous services as well as providing one or more open houses on the property and a live video walkthrough including responding to live audience questions. Other pricing models are possible as well.

FIG. 3 shows a communication flow for scenario 300 involving obtaining information about prospective real estate purchases using beacons, in accordance with at least some example embodiments. Scenario 300 involves a potential purchaser of real estate PP who owns computing device 110 having providing data via questionnaire 130 indicating a desire to purchase a condo or townhouse on/near Oak St in city C. In city C, several beacons have been set up for advertising real estate, including beacons 310, 312, 314, 316, where each of these beacons is located on (and so is associated with) a respective parcel of real estate RE310, RE312, RE314, RE316. In scenario 300, RE310 is an apartment for rent at 110 Oak St., RE312 is a townhouse for sale at 112 Oak St., RE314 is a shop for sale at 703 High St., and RE316 is a condo for sale at 222 Ash St. In scenario 300, each of beacons 310, 312, 314, 316 is located on the respective parcel of real estate RE310, RE312, RE314, RE316; in other scenarios, a beacon can be near but not on an associated parcel of real estate; e.g., within 100 feet, 70 yards, 50 meters, 3 stories of a building with the associated parcel of real estate, etc. Then, as the beacon is at or near the parcel of real estate, a beacon computing device associated with the beacon can calculate a distance between computing device 110 and the beacon computing device to determine proximity information for computing device 110 and the parcel of real estate associated with the beacon computing device, such as an actual or estimated distance between computing device 110 and the parcel of real estate, a location of computing device 110 that can be used to calculate proximity to the parcel of the real estate; i.e., providing the location of computing device 110 indirectly specifies proximity to a known location of the parcel of real estate; and/or an actual or estimated distance between computing device 110 and the beacon computing device.

Scenario 300 continues with potential purchaser PP taking a walk about city C carrying computing device 110. Before the walk, potential purchaser PP turns on computing device 110 and executes software application App1 on computing device 110 during the walk.

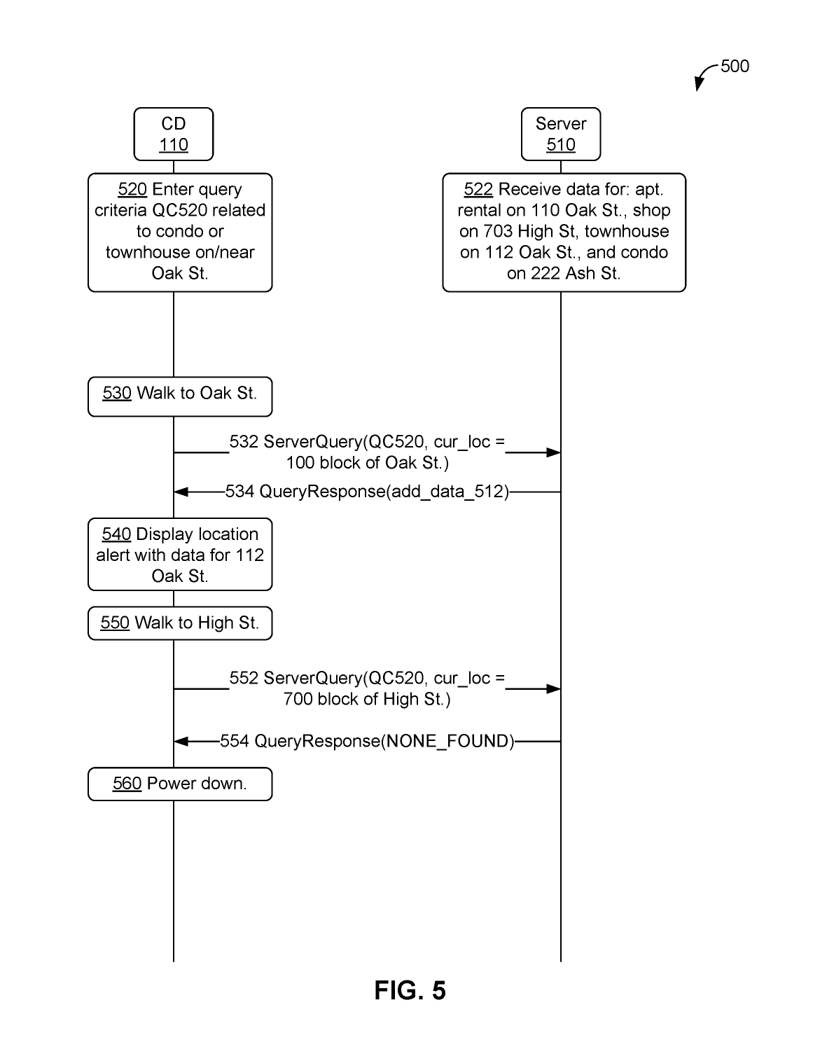

Potential purchaser PP starts the walk along the 100 block of Oak St. While on the 100 block of Oak St., computing device 110 broadcasts a request to locate proximate beacons along Oak St., and beacons 310 and 312 acknowledge the request. Computing device 110 then queries each of beacons 310 and 312 to determine whether either respective beacon has information about a condo or townhouse for sale. In other scenarios, computing device 110 can receive one or more beacon identifiers, property identifiers, and/or other property-related information (e.g., latitude/longitude information) and provide the beacon identifier, property identifier, and/or other property-related information to one or more server computing devices, such as discussed below at least in the context of scenario 500 and FIG. 5. In scenario 300, beacon 310 answers in the negative, and beacon 312 answers in the affirmative, and provides additional information about RE 312 (the townhouse on 112 Oak St.), which is then displayed by computing device 110. For example, beacon 310 can determine and/or record coordinates of computing device 110 and push a notification to provide additional information about RE 312.

Potential purchaser PP continues to walk from the 100 block of Oak St. onto the 700 block of High St. and enters into a coffee shop on High St. While PP is walking on the 700 block of High St., computing device 110 broadcasts a request to locate proximate beacons along High St., and beacon 314 acknowledges the request. Computing device 110 then queries beacon 314 to determine whether the beacon has information about a condo or townhouse for sale. In scenario 300, beacon 314 answers in the negative. Potential purchaser PP then enters into the coffee shop on High St. and powers down computing device 110, ending scenario 300.

As shown in FIG. 3, scenario 300 begins at block 320 where data about parcel of real estate RE310, which is an apartment rental at 110 Oak St. of city C, is input to a beacon computing device of beacon 310, and beacon 310 is activated. At block 322, data about parcel of real estate RE314, which is a shop for sale on 703 Oak St. of city C, is input to a beacon computing device of beacon 314, and beacon 314 is activated. At block 324, data about parcel of real estate RE312, which is a townhouse for sale on 112 Oak St. of city C, is input to a beacon computing device of beacon 312, and beacon 312 is activated. At block 326, data about parcel of real estate RE316, which is a condo for sale on 222 Ash St. of city C, is input to a beacon computing device of beacon 312, and beacon 312 is activated.

At block 328, potential purchaser PP, who is an owner of computing device 110, uses questionnaire 130 and related questionnaires to provide data to application App1 running and/or accessing a computing device running the above-mentioned recommendation algorithm. The data provided to App1 (and therefore, to the recommendation algorithm) indicates that PP is interested in buying a townhouse or condo on or near Oak St. in City C.

Scenario 300 continues at block 330 with PP walking on Oak St. of city C with computing device 110 turned on and executing App1. Upon execution of App1, PP directs App1 to display a real estate dashboard. FIG. 4, at left, shows an example of real estate dashboard 400 provided to PP. In scenario 300, dashboard 400 is provided by App1 using user interface 120 of computing device 110.

Dashboard 400 includes messages indicator 410, appointments region 420, property alerts region 430, pending offers region 440, recommended/recent parcels region 450, questionnaire button 460, settings button 462, and exit button 464. In other scenarios, dashboard 400 can provide more, less, and/or different information and/or use more, less, and/or different UI controls than shown in FIG. 4.

Messages indicator 410 can be used to provide information about available messages. Also, when messages indicator 410 is selected, dashboard 400 can provide a messaging interface to read, initiate, compose, edit, and/or send messages using messaging functionality, such as video call functionality, e-mail functionality, text messaging functionality, and/or telephone functionality. In some examples, App1 can provide the messaging functionality; in other examples, 3^{rd}-party supplied messaging functionality can be invoked by App1.

Appointments region 420 can show upcoming appointments related to real estate and push calendar appointments to a user's calendar on their device; e.g., a future showing of a property. In the example shown in FIG. 4, appointments region 420 shows upcoming appointments for the “Week of 6 Nov. 2017” that includes appointments on “11 November” that include a “2 PM” appointment at “432 Oak” and a “3 PM” appointment at “327 Ash”.

Property alerts region 430 provides information about “property alerts”, which are notifications generated by dashboard 400, App1, and/or a related computing device about information received by a beacon at a property and/or by one or more other devices. In some examples, a property alert can be provided after determining that the recommendation percentage of the property exceeds a threshold value; that is, property alerts are generated only for properties that are recommended by the recommendation algorithm. Further, as a property alert is generated by a beacon on or near the property, the property alert provides information about a recommended property that is (or was) nearby to computing device 110. Then, property alerts can both inform a user of dashboard 400 about nearby properties but can also confirm that the user is near a property of interest; e.g., if visiting the property in person for the first time just prior to a showing of the property.

Pending offers region 440 can provide data about one or more properties in the conveyance process; e.g., a property that has been offered, a property scheduled for closing, etc.

Recommended/recent parcels region 450 can provide information about: one or more properties of a recommended parcel list, one or more properties recently visited either in person or via a website and/or beacon-alerted properties. A website for property searches can be accessed via search button 452 of dashboard 400.

Questionnaire button 460, when selected, causes App1 to display questionnaire 130 so that a user of dashboard 400 can review, add, remove, and/or change data in questionnaire 130. After the user has finished with questionnaire 130, App1 can return to dashboard 400 or perform another action (e.g., return to a home page of App1 other than dashboard 400 that is not shown in the figures). Settings button 462, when selected, causes App1 to display settings to control visual, audio, communications, and other aspects of App1; e.g., general controls over App1, whether or not to provide an audible tone when a property alert is received, communications protocols used for sending/receiving beacon-related transmission, whether or not conveyancing services of App1 are to be used, etc. Exit button 464, when selected, causes App1 to close dashboard 400. In some examples, when exit button 464 is selected, App1 is subsequently terminated. If App1 is not executing on computing device 110; e.g. in foreground or background, then computing device 110 will not receive notifications about parcels—that is, if a user terminates App1 by force-closing App1, deleting App1, during a software or hardware fault, or any other way, notifications will not receive notifications about parcels.

Returning to FIG. 3, while App1 is executing, computing device 110 sends BroadcastBeaconReq message 332, which is a broadcast request for proximity and/or other information from beacons on “Oak St.” In other scenarios, BroadcastBeaconReq message 332 can request information from beacons based on other criteria than a street name, such as, but not limited to, latitude/longitude information, postal/zip code information, city/county/state/province information. In still other scenarios, BroadcastBeaconReq message 332 may not provide any criteria for a response, and thereby request information from any beacon in range of BroadcastBeaconReq message 332.

Scenario 300 proceeds with beacon 310, which is on 110 Oak St., acknowledging BroadcastBeaconReq message 332 using BeaconAck message 340, where BeaconAck message 340 provides an identifier “B310” for beacon 310 to computing device 110 and proximity information “P310” indicating that computing device 110 is 100 meters from RE310/110 Oak St. Beacon 312, which is on 112 Oak St., also acknowledges BroadcastBeaconReq message 332 by sending BeaconAck message 342 that includes an identifier “B312” for beacon 312 to computing device 110 and proximity information “P312” indicating that computing device 110 is 120 meters from RE312/112 Oak St.

Upon reception of BeaconAck message 340, computing device 110 sends BeaconQuery message 350 to beacon 310, where BeaconQuery message 350 includes identifier “B310” to address message 350 to beacon 310, and query criteria related to property types of condominiums and townhouses as a query of beacon 310. For example, a user of App1 can indicate preferences without key words, and the preference provided by the user can be weighted more heavily by the recommendation algorithm and/or be used as query criteria for beacon queries. As beacon 310 has information about an apartment rental, not for a condo or townhouse, beacon 310 determines that the query with query criteria related to property types of condominiums and townhouses fails and sends BeaconQR (for Query Response) message 352 to computing device 110 with a “NO” response indicating that the query of BeaconQuery message 350 failed. In other scenarios, a BroadcastBeaconReq message 332 includes query criteria; e.g., the query criteria related to property types of condominiums and townhouses of BeaconQuery message 350. In even other scenarios, BroadcastBeaconReq message 332 and/or BeaconQuery message 350 can include information about a maximum distance for the beacon to respond; e.g., a message from computing device 110, such as a BroadcastBeaconReq and/or a BeaconQuery message, can instruct the beacon not to respond if the beacon and/or associated parcel of real estate is beyond a maximum distance (e.g., 1000 ft., 1 km, 50 meters, 2 blocks) from computing device 110. In still other scenarios, more, less, and/or different query criteria are provided in a BeaconQuery message than shown in FIG. 3.

In scenario 300, computing device 110 silently ignores failing BeaconQR message 352; in other scenarios, computing device 110 can provide a response to BeaconQR message 352; e.g., provide a display indicating that beacon 310 was queried but the query failed; send a message acknowledging BeaconQR message 352.

Upon reception of BeaconAck message 342, computing device 110 sends BeaconQuery message 360 to beacon 312, where BeaconQuery message 360 includes identifier “B312” to address message 360 to beacon 312, and query criteria related to property types of condominiums and townhouses as a query of beacon 312. As beacon 312 has information about a townhouse of sale, beacon 312 determines that the query with query criteria related to property types of condominiums and townhouses succeeds and sends BeaconQR message 362 to computing device 110 with a “YES” response and additional data “add_data_312” indicating that the query of BeaconQuery message 360 succeeded and providing additional data add_data_312 for use by computing device 110.

At block 364, computing device 110 receives BeaconQR message 362, extracts the additional data add_data_312 from message 362, and generates a property alert with data about the condo for sale at 112 Oak St. as indicated by the additional data add_data_312. In other scenarios, more than one round of queries and query responses can be performed to query a beacon before an alert is generated; e.g., computing device 110 could form one or more additional queries and receive corresponding query responses to query beacon 312 about price, size, and/or other criteria about the townhouse at 112 Oak St. before generating an alert.

In scenario 300, a recommendation algorithm executing on computing device 110 determines a recommendation percentage for RE312 of REP 312, and determines that REP 312 exceeds a recommendation threshold RPThresh. As the recommendation percentage REP 312 exceeds RPThresh, computing device 110 generates an alert/indication about RE312/the condo for sale at 112 Oak St. In other scenarios, computing device 110 can generate an alert/indication about a parcel of real estate that matches criteria provided in one or more queries without determining a recommendation percentage for the parcel of real estate. In other scenarios, computing device 110 does not execute the recommendation algorithm; rather, one or more other computing devices, such as one or more servers, accessible to computing device 110 execute the recommendation algorithm as requested by computing device 110 and provide consequent outputs of the recommendation algorithm to computing device 110.

An example alert about the condo for sale at 112 Oak St. is shown as property alert 432 in dashboard 400 as depicted on the right side of FIG. 4. Property alert 432 includes data extracted by computing device 120 from add_data_312 about a condo for sale provided in message 362. The extracted data include the address of the condo for sale “112 Oak Street”, a description of the condo “A beautiful condominium in the heart of town. 3BR/3BA, 100 m² $429K”, and a reference (e.g., a Uniform Resource Locator (URL), Uniform Resource Identifier (URI)) for obtaining even more information. The reference can be followed by selecting “More” button 434 of alert 432. For example, the reference can be a link to a website providing images, audio, video, and/or additional textual information about the condo for sale at 112 Oak St.

Returning to FIG. 3, scenario 300 continues with PP continuing to walk by turning from Oak St. to the 700 block of High St., as indicated by block 370. After PP turns onto High St., computing device 110 sends BroadcastBeaconReq message 372, which is a broadcast request for information from beacons on “High St.”

Scenario 300 proceeds with beacon 314, which is on 703 High St., acknowledging BroadcastBeaconReq message 372 using BeaconAck message 380, where BeaconAck message 380 provides an identifier “B314” for beacon 314 to computing device 110 and proximity information “P314” indicating that computing device 110 is 347 meters from RE314/703 High St.

Upon reception of BeaconAck message 380, computing device 110 sends BeaconQuery message 382 to beacon 314, where BeaconQuery message 382 includes identifier “B314” to address message 382 to beacon 314, and query criteria related to property types of condominiums and townhouses as a query of beacon 314. As beacon 314 has information about a shop for sale, not for a condo or townhouse, beacon 314 determines that the query with query criteria related to property types of condominiums and townhouses fails and sends BeaconQR message 384 to computing device 110 with a “NO” response indicating that the query of BeaconQuery message 350 failed.

Scenario 300 continues with PP entering a coffee shop on High St. and then turning off computing device 110, as indicated at block 390. Upon completion of the procedures of block 390, scenario 300 can be completed. In scenario 300, beacon 316 did not come within range of computing device 110, and so beacon 316 was not queried during the scenario.

FIG. 5 shows a communication flow for scenario 500 involving obtaining information about prospective real estate purchases using a server computing device in accordance with at least some example embodiments. Scenario 500 involves a potential purchaser of real estate PP who owns computing device 110 having providing query criteria QC520 via questionnaire 130 indicating a desire to purchase a condo or townhouse on/near Oak St in city C. During scenario 500, one or more server computing devices 510, or server 510 for short, has a database storing information about several parcels of real estate in city including an apartment for rent at 110 Oak St., a townhouse for sale at 112 Oak St., a shop for sale at 703 High St., and a condo for sale at 222 Ash St.

Server 510 can receive a query from a computing device, that include query criteria and location data related to a current location of the computing device; e.g., a query can include query criteria QC520 and information related to a current location of computing device 110. Upon receiving the query, server 510 can send a query response regarding properties that satisfy query criteria QC520 and are at or near the current location of computing device 110. For example, server 510 can, after receiving the query criteria QC520 and information related to a current location of computing device 110, determine one or more parcels of real estate in a database of real estate parcels/properties that are within a threshold proximity (or distance) of the current location of computing device 110. Then, for each parcel of real estate within the threshold proximity, server 510 can execute the recommendation algorithm to determine a recommendation percentage for the parcel of real estate. And, if the recommendation percentage for the parcel of real estate (that is within the threshold proximity) exceeds the threshold recommendation percentage, server 510 can generate a notification about the parcel of real estate and send the notification to computing device 110. For example, the notification about the parcel of real estate can be similar to a beacon notification discussed above with regards to scenario 300. Upon receiving the notification, computing device 110 can generate an output, such as an alert and/or an update of a dashboard that is similar to a property alert discussed above with regards to scenario 300.

Scenario 500 continues with potential purchaser PP taking a walk about city C carrying computing device 110. Before the walk, potential purchaser PP turns on computing device 110 and executes software application App1 on computing device 110 during the walk. Potential purchaser PP begins by walking along the 100 block of Oak St. While on the 100 block of Oak St., computing device 110 sends a message to server 500 with query criteria QC520 and proximity information indicating that computing device 110 is on the 100 block of Oak St. In other scenarios, computing device 110 can send additional and/or different information to server 510; e.g., one or more beacon identifiers, property identifiers, and/or other property-related information (e.g., latitude/longitude information). Continuing scenario 500, server 510 receives query criteria QC520 and proximity information indicating that computing device 110 is on the 100 block of Oak St. and determines whether one or more parcels specified by query criteria QC520 are on the 100 block of Oak St.; e.g., whether the provided query criteria identify a condo or townhouse are near computing device 110, which is on the 100 block of Oak St. Server 510 subsequently provides additional information about the townhouse on 112 Oak St. and the additional information is displayed by computing device 110.

Potential purchaser PP continues to walk from the 100 block of Oak St. onto the 700 block of High St. and enters into a coffee shop on High St. While PP is walking on the 700 block of High St., sends a message to server 500 with query criteria QC520 and proximity information indicating that computing device 110 is on the 700 block of High St. Server 510 receives query criteria QC520 and proximity information indicating that computing device 110 is on the 700 block of High St. and determines whether one or more parcels specified by query criteria QC520 are on the 700 block of Oak St. In scenario 500, no parcels specified by query criteria QC520 are on the 700 block of Oak St., and server 510 informs computing device 110 of this fact. Potential purchaser PP then enters into the coffee shop on High St. and powers down computing device 110, ending scenario 500.

As shown in FIG. 5, scenario 500 begins at block 520, where potential purchaser PP, who is an owner of computing device 110, uses questionnaire 150 and related questionnaires to provide query criteria QC520 to application App1 running and/or accessing a computing device running the above-mentioned recommendation algorithm. Query criteria QC520 provided to App1 (and therefore, to the recommendation algorithm) indicates that PP is interested in buying a townhouse or condo on or near Oak St. in City C.

At block 522, server 510 has received data that includes data about at least four parcels of real estate: an apartment rental at 110 Oak St. of city C, a shop for sale on 705 Oak St. of city C, a townhouse for sale on 112 Oak St. of city C, and a condo for sale on 222 Ash St. of city C. In other scenarios, server 510 can receive and/or store data about more, fewer, and/or different parcels of real estate. This received data is stored in a real estate database of server 510.

At block 530, potential purchaser PP walks on Oak St. of city C with computing device 110 turned on and executing App1. Upon execution of App1, PP directs App1 to display a real estate dashboard, such discussed above in the context of dashboard 400 and FIGS. 3 and 4. In scenario 500, the real estate dashboard is dashboard 400 provided by App1 using user interface 120 of computing device 110.

In scenario 500, property alerts region 430 of dashboard 400 provides information about both property alerts as discussed above, and query responses from server 510. Query responses of scenario 500 are responses to queries provided by computing device 110, where a query includes query criteria; e.g., query criteria QC520, about real estate parcels of interest to potential purchaser PP and proximity information, indicating one or more locations that are proximate to computing device 110. In response to receiving a query response from server 510, dashboard 400 can generate a notification if the query response indicates that one or more properties meet the query criteria and are proximate to computing device 110 (as indicated by the proximity information provided in a corresponding query). The generated notification can be the same as or similar to a property alert; e.g., property alert 432, where property alerts are discussed above in the context of at least FIG. 4.

While App1 is executing, computing device 110 sends ServerQuery message 532 that includes query criteria QC520, about real estate parcels of interest to potential purchaser PP and proximity information “cur_loc” indicating that computing device 110 is on the “100 block of Oak St.”. In other scenarios, other types of proximity information; e.g., a location specified by latitude and longitude, can be provided as proximity information to server 510. In still other scenarios, a query message, such as ServerQuery message 532, can include more, less, and/or different information. In response to ServerQuery message 532, server 510 uses query criteria QC520 and the proximity location provided in ServerQuery message 532 to query its real estate database. In response to the query, server 510 finds query response data “add_data_512” in the real estate database about a real estate parcel that meets query criteria QC520 and is proximate to the proximity location provided in ServerQuery message 532. In particular, the query response data add_data_512 includes the address of the condo for sale “112 Oak Street”, a description of the condo “A beautiful condominium in the heart of town. 3BR/3BA, 100 m² $429K”, and a reference (e.g., a URL, a URI) for obtaining even more information. In other scenarios, the query response data can include more, less, and/or different data about real estate parcels found by server 510. After obtaining query response data add_data_512, server 510 sends QueryResponse message 534 that includes the query response data add_data_512 to computing device 110.

In some scenarios, such as scenario 300 and/or scenario 500, a recommendation percentage can be determined and provided for display as part of a property alert and/or a notification to a query response. In scenario 500, server 510 determines a recommendation percentage for 112 Oak Street and provides the recommendation percentage as part of add_data_512. In some variations of scenario 300, a recommendation percentage can be determined as part of add_data_312 and/or calculated based on add_data_312. Then, computing device 110 can display the received recommendation percentage as part of a property alert and/or a notification of a query response. For example, the right side of FIG. 4 shows that computing device 110 displays property alert 432 with a “Recommendation Percentage” of “97%” for “112 oAK sTREET”.

At block 540 of FIG. 5, computing device 110 receives QueryResponse message 534, extracts the query response data add_data_512, and generates an alert similar to property alert 432 with data about the condo for sale at 112 Oak St. as indicated by the additional data add_data_512. In other scenarios, more than one round of queries and query responses can be performed to query server 510 before a corresponding alert is generated; e.g., computing device 110 could form one or more additional queries and receive corresponding query responses from server 510 about price, size, and/or other criteria about the townhouse at 112 Oak St. before generating an alert.

Scenario 500 continues with PP continuing to walk by turning from Oak St. to the 700 block of High St., as indicated by block 540. After PP turns onto High St., computing device 110 sends ServerQuery message 552 that includes query criteria QC520 and proximity information “cur_loc” indicating that computing device 110 is on the “700 block of High St.”. In response to ServerQuery message 552, server 510 uses query criteria QC520 and the proximity location provided in ServerQuery message 552 to query its real estate database. In response to the query, server 510 does not find any parcels matching query criteria QC520 and the proximity location provided in ServerQuery message 552 in its real estate database. Then, server 510 sends QueryResponse message 554 with a “NONE_FOUND” indicator to inform computing device 110 that no parcels were found by server 510 in response to ServerQuery message 552. In other scenarios, the query response message can include more, less, and/or different data about a lack of real estate parcels found by server 510. In scenario 500, computing device 110 silently ignores failing ServerQuery message 552 as ServerQuery message 552 has a “NONE_FOUND” indicator; in other scenarios, computing device 110 can provide a response to ServerQuery message 552; e.g., provide a display indicating that server 510 was queried but the query failed.

Scenario 500 continues with PP entering a coffee shop on High St. and then turning off computing device 110, as indicated at block 560. Upon completion of the procedures of block 560, scenario 500 can be completed.

Example Data Network

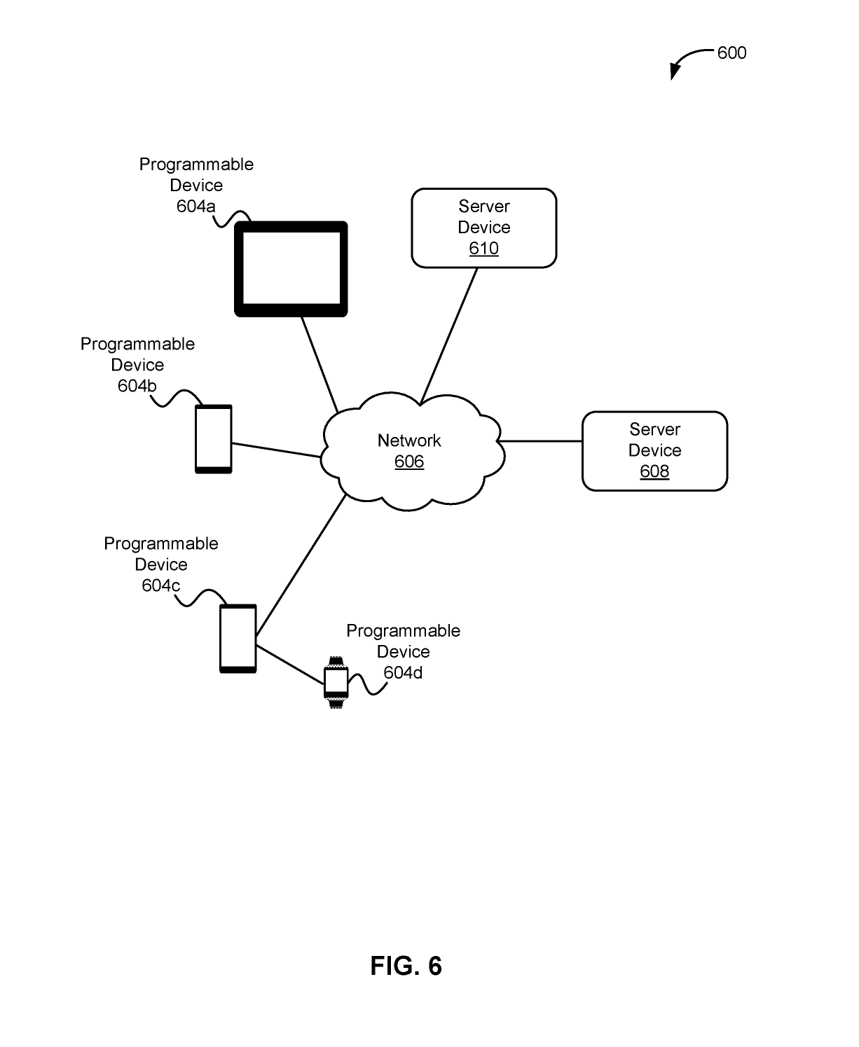

FIG. 6 depicts a distributed computing architecture 600 with server devices 608, 610 configured to communicate, via network 606, with programmable devices 604a, 604b, 604c, 604d, in accordance with at least some example embodiments. Network 606 may correspond to a LAN, a wide area network (WAN), a corporate intranet, the public Internet, or any other type of network configured to provide a communications path between networked computing devices. Network 606 may also correspond to a combination of one or more LANs, WANs, corporate intranets, and/or the public Internet.

Although FIG. 6 shows four programmable devices, distributed computing architecture 600 can serve more, fewer, and/or different programmable devices. Moreover, programmable devices 604a, 604b, 604c, 604d (or any additional programmable devices) may be any sort of computing device, such as an ordinary laptop computer, desktop computer, wearable computing device, mobile computing device, head-mountable device (HMD), network terminal, wireless communication device (e.g., a smart phone or cell phone), and so on. In some embodiments, such as indicated with programmable devices 604a, 604b, 604c, programmable devices can be directly connected to network 606. In other embodiments, such as indicated with programmable device 604d, one or more programmable devices can be indirectly connected to network 606 via an associated computing device, such as programmable device 604c. In this example, programmable device 604c can act as an associated computing device to pass electronic communications between programmable device 604d and network 606. In still other embodiments not shown in FIG. 6, a programmable device can be both directly and indirectly connected to network 606.

Server devices 608, 610 can be configured to perform one or more services, as requested by programmable devices 604a-604d. For example, server device 608 and/or 610 can provide content to programmable devices 604a-604d. The content can include, but is not limited to, web pages, hypertext, scripts, binary data such as compiled software, images, audio, and/or video. The content can include compressed and/or uncompressed content. The content can be encrypted and/or unencrypted. In some examples, the content can be related to real estate. Other types of content are possible as well.

As another example, server device 608 and/or 610 can provide programmable devices 604a-604d with access to software for database, search, computation, graphical, audio, video, World Wide Web/Internet utilization, and/or other functions. Many other examples of server devices are possible as well.

Computing Device Architecture

FIG. 7 is a functional block diagram of computing device 700, in accordance with at least some example embodiments. In particular, computing device 700 shown in FIG. 7 can be configured to perform at least one function related to one or more of: a recommendation algorithm, real estate purchasing system 100, computing device 110, 110a, user interface 120, questionnaire 130, beacon 210, 220, 310, 312, 314, 316, sign 212, 222, beacon computing device 214, 224, dashboard 400, scenarios 300, 500, and method 800.

Computing device 700 may include a user interface module 701, a network-communication interface module 702, one or more processors 703, data storage 704, and one or more sensors 720, all of which may be linked together via a system bus, network, or other connection mechanism 705.

User interface module 701 can be operable to send data to and/or receive data from external user input/output devices. For example, user interface module 701 can be configured to send and/or receive data to and/or from user input devices such as a keyboard, a keypad, a touch screen, a computer mouse, a track ball, a joystick, a camera, a voice recognition module, and/or other similar devices. User interface module 701 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 701 can also be configured to generate audible output(s), such as a speaker, speaker jack, audio output port, audio output device, earphones, and/or other similar devices. User interface module 701 can further be configured with one or more haptic devices that can generate haptic output(s), such as vibrations and/or other outputs detectable by touch and/or physical contact with computing device 700. In some embodiments, user interface module 701 can be used to provide a graphical user interface (GUI) for utilizing computing device 700.

Network-communications interface module 702 can include one or more wireless interfaces 707 and/or one or more wireline interfaces 708 that are configurable to communicate via a network. Wireless interfaces 707 can include one or more wireless transmitters, receivers, and/or transceivers, such as a Bluetooth™ transceiver, a Zigbee® transceiver, a Wi-Fi™ transceiver, a WiMAX™ transceiver, a 2G transceiver, a 3G transceiver, a 4G transceiver, a 5G transceiver, and/or other similar type of wireless transceiver configurable to communicate via a wireless network. Wireline interfaces 708 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some embodiments, network communications interface module 702 can be configured to provide reliable, secured, and/or authenticated communications. For each communication described herein, information for ensuring reliable communications (i.e., guaranteed message delivery) can be provided, perhaps as part of a message header and/or footer (e.g., packet/message sequencing information, encapsulation header(s) and/or footer(s), size/time information, and transmission verification information such as CRC and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), an Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 703 can include one or more general purpose processors, and/or one or more special purpose processors (e.g., digital signal processors, graphics processing units, application specific integrated circuits, etc.). One or more processors 703 can be configured to execute computer-readable program instructions 706 that are contained in data storage 704 and/or other instructions as described herein.

Data storage 704 can include one or more computer-readable storage media that can be read and/or accessed by at least one of one or more processors 703. The one or more computer-readable storage media can include volatile and/or non-volatile storage components, such as optical, magnetic, organic or other memory or disc storage, which can be integrated in whole or in part with at least one of one or more processors 703. In some embodiments, data storage 704 can be implemented using a single physical device (e.g., one optical, magnetic, organic or other memory or disc storage unit), while in other embodiments, data storage 704 can be implemented using two or more physical devices.

Data storage 704 can include computer-readable program instructions 706 and perhaps additional data. In some embodiments, data storage 704 can additionally include storage required to perform at least part of the herein-described methods, scenarios, and techniques and/or at least part of the functionality of the herein-described devices and networks. For example, computer-readable program instructions 706 can, when executed by one or more processors 703, cause computing device 700 to perform at least one function related to one or more of: a recommendation algorithm, real estate purchasing system 100, computing device 110, 110a, user interface 120, questionnaire 130, beacon 210, 220, 310, 312, 314, 316, sign 212, 222, beacon computing device 214, 224, dashboard 400, scenarios 300, 500, and method 800.

In some embodiments, computing device 700 can include one or more sensors 720. Sensor(s) 720 can be configured to measure conditions in an environment of computing device 700 and provide data about that environment. For example, sensor(s) 720 can include one or more of: (i) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensor(s) can be configured to read identifiers, such as RFID tags, barcodes, QR codes, and/or other devices and/or object configured to be read and provide at least identifying information; (ii) sensors to measure locations and/or movements of computing device 700, such as, but not limited to, a tilt sensor, a gyroscope, an accelerometer, a Doppler sensor, a GPS device, a sonar sensor, a radar device, a laser-displacement sensor, and a compass; and (iii) an environmental sensor to obtain data indicative of an environment of computing device 700, such as, but not limited to, an infrared sensor, an optical sensor, a light sensor, a camera, a biosensor, a capacitive sensor, a touch sensor, a temperature sensor, a wireless sensor, a radio sensor, a movement sensor, a microphone, a sound sensor, an ultrasound sensor, and/or a smoke sensor; Many other examples of sensor(s) 720 are possible as well.

Example Methods of Operation

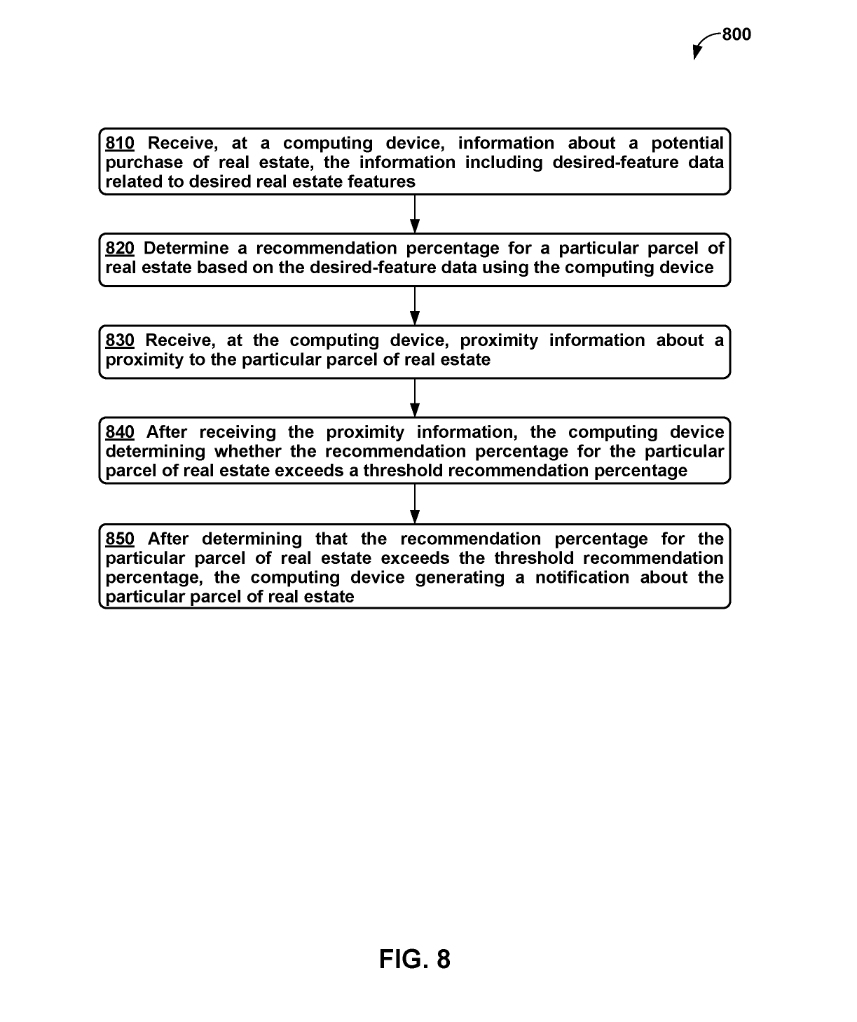

FIG. 8 is a flowchart of method 800, in accordance with at least some example embodiments. Method 800 can be executed by a computing device, such as computing device 700. Method 800 can begin at block 810, where the computing device can receive information about a potential purchase of real estate, where the information can include desired-feature data related to desired real estate features, such as discussed above at least in the context of FIGS. 1, 3, and 5. In some embodiments, receiving the information about a potential purchase of real estate can include receiving the desired-feature data using a questionnaire provided using a user interface of the computing device, such as discussed above at least in the context of FIG. 1. In other embodiments, the desired-feature data can include desirability information about images of parcels of real estate, such as discussed above at least in the context of FIG. 1.

At block 820, the computing device can determine a recommendation percentage for a particular parcel of real estate based on the desired-feature data, such as discussed above at least in the context of FIGS. 1, 3, and 5.

In some embodiments, determining the recommendation percentage for a particular parcel of real estate can include determining the recommendation percentage based on the related-feature data and/or additional data, and where the additional data includes data and/or metadata related to one or more of: an accuracy of a recommendation for the particular parcel of real estate, viewing time on specific photos of the particular parcel of real estate, one or more room sizes, coziness and/or openness information for one or more rooms, social media shares associated with the particular parcel of real estate, home purchase data and/or recommendation percentages for real estate that is comparable to the particular parcel of real estate, scheduled home viewings, actual and/or estimated ongoing maintenance costs for the particular parcel of real estate, layout and/or flow of the particular parcel of real estate, an entrance to the particular parcel of real estate, proximity to neighbors, friends and/or family members from the particular parcel of real estate, proximity to bars, restaurants and/or other entertainment choices from the particular parcel of real estate, proximity to an office from the particular parcel of real estate, proximity to public transport and/or airports from the particular parcel of real estate, direction of the sun in relationship to the particular parcel of real estate, proximity to specific schools and/or highly-rated school districts from the particular parcel of real estate, crime statistics for a surrounding area of the particular parcel of real estate, population density of the surrounding area, a mood of the surrounding area, recreational features of the particular parcel of real estate, and parking information about the particular parcel of real estate, such as discussed above in the context of at least FIG. 1.

In other embodiments, determining the recommendation percentage for the particular parcel of real estate can include determining a recommendation percentage for the particular parcel of real estate using a recommendation algorithm utilizing one or more machine learning techniques, such as discussed above in the context of at least FIG. 1.

At block 830, the computing device can receive proximity information about a proximity to the particular parcel of real estate, such as discussed above at least in the context of FIGS. 1-3 and 5. For example, the proximity to the particular parcel of real estate can be directly specified as a proximity of the computing device to the particular parcel of real estate or indirectly specified as a location of the computing device, and then the proximity from the location of the computing device to a known location of the particular parcel of real estate can be determined.

In some embodiments, receiving proximity information about the proximity to the particular parcel of real estate can include receiving the proximity information from a beacon located at or near the particular parcel of real estate e, such as discussed above at least in the context of FIGS. 1-3. In other embodiments, the beacon can include a sign advertising the particular parcel of real estate, such as discussed above at least in the context of FIG. 2. In even other embodiments, the beacon includes an embedded beacon computing device; then, receiving the proximity information from the beacon can include receiving the proximity information from the embedded beacon computing device, such as discussed above at least in the context of FIG. 2. In still other embodiments, the proximity information about the proximity to the particular parcel of real estate can include a distance between the computing device and the beacon, such as discussed above at least in the context of FIGS. 1 and 3.

At block 840, the computing device can, after receiving the proximity information, determine whether the recommendation percentage for the particular parcel of real estate exceeds a threshold recommendation percentage, such as discussed above at least in the context of FIGS. 1, 3, and 5.

At block 850, the computing device can, after determining that the recommendation percentage for the particular parcel of real estate exceeds the threshold recommendation percentage, generate a notification about the particular parcel of real estate, such as discussed above at least in the context of FIGS. 1, 3, 4, and 5. In some embodiments, generating the notification about the particular parcel of real estate can include: after receiving the proximity information about the proximity to the particular parcel of real estate, the computing device determining whether the recommendation percentage for the particular parcel of real estate exceeds a threshold recommendation percentage and determining whether the proximity to the particular parcel of real estate is within a threshold proximity; and after determining that recommendation percentage for the particular parcel of real estate exceeds the threshold recommendation percentage and that the proximity to the particular parcel of real estate is within a threshold proximity, the computing device generating the notification about the particular parcel of real estate; such as discussed above at least in the context of FIG. 5.

In some embodiments, method 800 can further include: displaying a dashboard related to the potential purchase of real estate using the computing device, such as discussed above at least in the context of FIG. 4. In particular of these embodiments, generating the notification about the particular parcel of real estate can include displaying the notification about the particular parcel of real estate using the dashboard, such as discussed above at least in the context of FIGS. 3 and 4. In other embodiments, the notification about the particular parcel of real estate includes information about how a current owner of the particular parcel of real estate utilizes the particular parcel of real estate, such as discussed above at least in the context of FIG. 3. In particular of these embodiments, the information about how the current owner of the particular parcel of real estate utilizes the particular parcel of real estate can include information about how the current owner of the particular parcel of real estate utilizes one or more particular rooms in one or more particular buildings on the particular parcel of real estate, such as discussed above at least in the context of FIG. 3. In even other embodiments, method 800 can further include: providing an output of the computing device based on the generated notification about the particular parcel of real estate, such as discussed above at least in the context of FIGS. 3-5.

### Additional Example Embodiments

Clause 1—A method, including: receiving, at a computing device, information about a potential purchase of real estate, the information including desired-feature data related to desired real estate features; determining a recommendation percentage for a particular parcel of real estate based on the desired-feature data using the computing device; receiving, at the computing device, proximity information about a proximity to the particular parcel of real estate, after receiving the proximity information, the computing device determining whether the recommendation percentage for the particular parcel of real estate exceeds a threshold recommendation percentage; and after determining that the recommendation percentage for the particular parcel of real estate exceeds the threshold recommendation percentage, the computing device generating a notification about the particular parcel of real estate.

Clause 2—The method of Clause 1, where receiving the information about a potential purchase of real estate includes receiving the desired-feature data using a questionnaire provided using a user interface of the computing device.

Clause 3—The method of either Clause 1 or Clause 2, where the determining the recommendation percentage for a particular parcel of real estate includes determining the recommendation percentage based on the related-feature data and/or additional data, and where the additional data includes data and/or metadata related to one or more of: an accuracy of a recommendation for the particular parcel of real estate, viewing time on specific photos of the particular parcel of real estate, one or more room sizes, coziness and/or openness information for one or more rooms, social media shares associated with the particular parcel of real estate, home purchase data and/or recommendation percentages for real estate that is comparable to the particular parcel of real estate, scheduled home viewings, actual and/or estimated ongoing maintenance costs for the particular parcel of real estate, layout and/or flow of the particular parcel of real estate, an entrance to the particular parcel of real estate, proximity to neighbors, friends and/or family members from the particular parcel of real estate, proximity to bars, restaurants and/or other entertainment choices from the particular parcel of real estate, proximity to an office from the particular parcel of real estate, proximity to public transport and/or airports from the particular parcel of real estate, direction of the sun in relationship to the particular parcel of real estate, proximity to specific schools and/or highly-rated school districts from the particular parcel of real estate, crime statistics for a surrounding area of the particular parcel of real estate, population density of the surrounding area, a mood of the surrounding area, recreational features of the particular parcel of real estate, and parking information about the particular parcel of real estate.

Clause 4—The method of any one of Clauses 1-3, where determining the recommendation percentage for the particular parcel of real estate includes determining a recommendation percentage for the particular parcel of real estate using a recommendation algorithm utilizing one or more machine learning techniques.

Clause 5—The method of any one of Clauses 1-4, where receiving proximity information about the proximity to the particular parcel of real estate includes receiving the proximity information from a beacon located at or near the particular parcel of real estate.

Clause 6—The method of Clause 5, where the beacon includes an embedded beacon computing device, and where receiving the proximity information from the beacon includes receiving the proximity information from the embedded beacon computing device.

Clause 7—The method of either Clause 5 or Clause 6, where the beacon includes a sign advertising the particular parcel of real estate.

Clause 8—The method of any one of Clauses 5-7, where the proximity information about the proximity to the particular parcel of real estate includes a distance between the computing device and the beacon.

Clause 9—The method of any one of Clauses 1-8, where the desired-feature data includes desirability information about images of parcels of real estate.

Clause 10—The method of any one of Clauses 1-9, further including: displaying a dashboard related to the potential purchase of real estate using the computing device.

Clause 11—The method of Clause 10, where generating the notification about the particular parcel of real estate includes displaying the notification about the particular parcel of real estate using the dashboard.

Clause 12—The method of any one of Clauses 1-11, where the notification about the particular parcel of real estate includes information about how a current owner of the particular parcel of real estate utilizes the particular parcel of real estate.

Clause 13—The method of any one of Clauses 1-12, where the information about how the current owner of the particular parcel of real estate utilizes the particular parcel of real estate includes information about how the current owner of the particular parcel of real estate utilizes one or more particular rooms in one or more particular buildings on the particular parcel of real estate.

Clause 14—The method of any one of Clauses 1-13, where generating the notification about the particular parcel of real estate includes: after receiving the proximity information about the proximity to the particular parcel of real estate, the computing device determining whether the recommendation percentage for the particular parcel of real estate exceeds a threshold recommendation percentage and determining whether the proximity to the particular parcel of real estate is within a threshold proximity; and after determining that recommendation percentage for the particular parcel of real estate exceeds the threshold recommendation percentage and that the proximity to the particular parcel of real estate is within a threshold proximity, the computing device generating the notification about the particular parcel of real estate.

Clause 15—The method of any one of Clauses 1-14, further including: providing an output of the computing device based on the generated notification about the particular parcel of real estate.

Clause 16—A system, including: a computing device, where the computing device includes one or more processors, and one or more computer-readable media with computer-executable instructions stored thereon that, when executed by the one or more processors of the computing device, cause the computing device to carry out the method of any one of Clauses 1-15.

Clause 17—The system of Clause 16, further including a beacon located at or near the particular parcel of real estate, and where receiving proximity information about the proximity to the particular parcel of real estate includes receiving the proximity information from the beacon.

Clause 18—The system of Clause 16 or Clause 17, where the one or more computer-readable media are one or more non-transitory computer-readable media.

Clause 19—A computing device, including means to carry out the method of any one of Clauses 1-15.

Clause 20—One or more computer-readable media with computer-executable instructions stored thereon that, when executed by a one or more processors of a computing device, cause the computing device to carry out the method of any one of Clauses 1-15.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are for provided for explanatory purposes and are not intended to be limiting, with the true scope being indicated by the following claims.

What is claimed is:

1. A method, comprising:
receiving, at a computing device, information about a potential purchase of real estate, the information comprising desired-feature data related to desired real estate features;
determining a recommendation percentage for a particular parcel of real estate based on the desired-feature data using the computing device;
receiving, at the computing device, proximity information about a proximity to the particular parcel of real estate,
after receiving the proximity information, the computing device determining whether the recommendation percentage for the particular parcel of real estate exceeds a threshold recommendation percentage; and
after determining that the recommendation percentage for the particular parcel of real estate exceeds the threshold recommendation percentage, the computing device generating a notification about the particular parcel of real estate.

2. The method of claim 1, wherein receiving the information about a potential purchase of real estate comprises receiving the desired-feature data using a questionnaire provided using a user interface of the computing device.

3. The method of claim 1, wherein receiving the desired-feature data using the questionnaire comprises:
receiving information about one or more parcels of real estate, the one or more parcels of real estate comprising the particular parcel of real estate, wherein the information about one or more parcels of real estate comprises images of the one or more parcels of real estate;
processing the images of the one or more parcels of real estate to determine one or more features associated with the one or more parcels of real estate;
determining one or more questions related to the one or more features associated with the one or more parcels of real estate;
providing a questionnaire that includes the one or more questions; and
after providing a questionnaire that includes the one or more questions, receiving data comprising answers to at least one question of the one or more questions.

4. The method of claim 1, wherein the determining the recommendation percentage for a particular parcel of real estate comprises determining the recommendation percentage based on the related-feature data and/or additional data, and wherein the additional data comprises data and/or metadata related to one or more of: an accuracy of a recommendation for the particular parcel of real estate, viewing time on specific photos of the particular parcel of real estate, one or more room sizes, coziness and/or openness information for one or more rooms, social media shares associated with the particular parcel of real estate, home purchase data and/or recommendation percentages for real estate that is comparable to the particular parcel of real estate, scheduled home viewings, actual and/or estimated ongoing maintenance costs for the particular parcel of real estate, layout and/or flow of the particular parcel of real estate, an entrance to the particular parcel of real estate, proximity to neighbors, friends and/or family members from the particular parcel of real estate, proximity to bars, restaurants and/or other entertainment choices from the particular parcel of real estate, proximity to an office from the particular parcel of real estate, proximity to public transport and/or airports from the particular parcel of real estate, direction of the sun in relationship to the particular parcel of real estate, proximity to specific schools and/or highly-rated school districts from the particular parcel of real estate, crime statistics for a surrounding area of the particular parcel of real estate, population density of the surrounding area, a mood of the surrounding area, recreational features of the particular parcel of real estate, and parking information about the particular parcel of real estate.

5. The method of claim 1, wherein determining the recommendation percentage for the particular parcel of real estate comprises determining a recommendation percentage for the particular parcel of real estate using a recommendation algorithm utilizing one or more machine learning techniques.

6. The method of claim 1, wherein receiving proximity information about the proximity to the particular parcel of real estate comprises receiving the proximity information from a beacon located at or near the particular parcel of real estate.

7. The method of claim 6, wherein the beacon comprises an embedded beacon computing device, and wherein receiving the proximity information from the beacon comprises receiving the proximity information from the embedded beacon computing device.

8. The method of claim 6, wherein the beacon comprises a sign advertising the particular parcel of real estate.

9. The method of claim 6, wherein the proximity information about the proximity to the particular parcel of real estate comprises a distance between the computing device and the beacon.

10. The method of claim 1, wherein the desired-feature data comprises desirability information about images of parcels of real estate.

11. The method of claim 1, further comprising:
displaying a dashboard related to the potential purchase of real estate using the computing device; and
wherein generating the notification about the particular parcel of real estate comprises displaying the notification about the particular parcel of real estate using the dashboard.

12. The method of claim 1, wherein the notification about the particular parcel of real estate comprises information about how a current owner of the particular parcel of real estate utilizes the particular parcel of real estate.

13. The method of claim 1, wherein the information about how the current owner of the particular parcel of real estate utilizes the particular parcel of real estate comprises information about how the current owner of the particular parcel of real estate utilizes one or more particular rooms in one or more particular buildings on the particular parcel of real estate.

14. The method of claim 1, wherein generating the notification about the particular parcel of real estate comprises:
after receiving the proximity information about the proximity to the particular parcel of real estate, the computing device determining whether the recommendation percentage for the particular parcel of real estate exceeds a threshold recommendation percentage and determining whether the proximity to the particular parcel of real estate is within a threshold proximity; and
after determining that recommendation percentage for the particular parcel of real estate exceeds the threshold recommendation percentage and that the proximity to the particular parcel of real estate is within a threshold proximity, the computing device generating the notification about the particular parcel of real estate.

15. The method of claim 1, further comprising:
providing an output of the computing device based on the generated notification about the particular parcel of real estate.

16. A system, comprising:
a computing device, wherein the computing device comprises one or more processors, and one or more computer-readable media with computer-executable instructions stored thereon that, when executed by the one or more processors of the computing device, cause the computing device to carry out functions comprising:
receiving information about a potential purchase of real estate, the information comprising desired-feature data related to desired real estate features;
determining a recommendation percentage for a particular parcel of real estate based on the desired-feature data;
receiving proximity information about a proximity to the particular parcel of real estate,
after receiving the proximity information, determining whether the recommendation percentage for the particular parcel of real estate exceeds a threshold recommendation percentage; and
after determining that the recommendation percentage for the particular parcel of real estate exceeds the threshold recommendation percentage, generating a notification about the particular parcel of real estate.

17. The system of claim 16, further comprising a beacon located at or near the particular parcel of real estate, and wherein receiving proximity information about the proximity to the particular parcel of real estate comprises receiving the proximity information from the beacon.

18. The system of claim 16, wherein the one or more computer-readable media are one or more non-transitory computer-readable media.

19. One or more computer-readable media with computer-executable instructions stored thereon that, when executed by a one or more processors of a computing device, cause the computing device to carry out functions comprising:
receiving information about a potential purchase of real estate, the information comprising desired-feature data related to desired real estate features;
determining a recommendation percentage for a particular parcel of real estate based on the desired-feature data;
receiving proximity information about a proximity to the particular parcel of real estate,
after receiving the proximity information, determining whether the recommendation percentage for the particular parcel of real estate exceeds a threshold recommendation percentage; and
after determining that the recommendation percentage for the particular parcel of real estate exceeds the threshold recommendation percentage, generating a notification about the particular parcel of real estate.

20. The one or more computer-readable media of claim 19, wherein the one or more computer-readable media are one or more non-transitory computer-readable media.
